(19) United States
(12) Patent Application Publication
(10) Pub. No.: US 2004/0070633 A1
(43) Pub. Date: Apr. 15, 2004

(54) Electronic paper file and mark setting system

(76) Inventors: Tetsuroh Nakamura, Hyogo (JP); Hiroyuki Matsuo, Osaka (JP); Masaichiro Tatekawa, Osaka (JP)

Correspondence Address: MCDERMOTT WILL & EMERY, 600 13TH STREET, N.W., WASHINGTON, DC, 20005-3096, US

(21) Appl. No.: 10/466,340

(22) PCT Filed: Jan. 11, 2002
(86) PCT No.: PCT/JP02/00163

(30) Foreign Application Priority Data
Jan. 15, 2001 (JP) 2001-6826
Jan. 15, 2001 (JP) 2001-6827
Jan. 16, 2001 (JP) 2001-7961
Jan. 16, 2001 (JP) 2001-7962

(51) Int. Cl. G09G 5/00

(52) U.S. Cl. 345/860

(57) ABSTRACT

An electronic paper file comprises an electronic paper which is flexible medium and a main unit to which a plurality of the electronic papers is attached. The electronic paper file is characterized by comprising a mark indication control means for controlling the indication of a mark on an electronic paper. According to this electronic paper file, a mark can be indicated on an electronic paper displaying specified character strings or the like, so that the user can find out a desired page easily.

### TECHNICAL FIELD

This invention relates to an electronic paper file attachable with a plurality of electronic papers

### BACKGROUND ART

As the information society progresses in these years, the performance of the display medium, such as CRT (Cathode Ray Tube) and LCD (Liquid Crystal Display), has been improved rapidly. But such display medium is not superior to the paper, which has been used as an information medium for many years, regarding the readability and the user-friendly. Then as a flexible display medium, the concept of the electronic paper is suggested and various methods to carry out the electronic paper have been studied (Pages 209 to 251 of “Japan Hardcopy'99—The Collected Papers” published by The Imaging Society in Japan).

And it is also suggested the electronic paper file wherein a plurality of such electronic papers are formed in a notebook-like form (Published Japanese translation of PCT application, No. 11-502950). Additionally, as well as such electronic paper file can manage a plurality of electronic papers easily, it can put the electronic paper to practical use as a display medium with the readability and the user-friendly.

However, the conventional electronic paper file, wherein a plurality of electronic papers are attached to the main unit, has a problem that it is very difficult for a user to find a desired page among those electronic papers. The invention is proposed based on the above problem and has an object to makes it possible to find a desired page easily.

### DISCLOSURE OF INVENTION

The present invention comprises following means in order to achieve the above object.

That is to say, the invention presupposes an electronic paper file comprising an electronic paper that is a flexible display medium and a main unit attachable with a plurality of said electronic papers. The electronic paper file is provided with a mark indication control means for controlling the indication of a mark on the electronic paper.

The electronic paper file configured as above can indicate a mark on an electronic paper displaying specified character strings, so that a user can find a desired page easily.

### BRIEF DESCRIPTION OF DRAWINGS

FIG. 1 is a configuration view of an electronic paper file to which the invention is applied.

FIG. 2 is an outline view of an electronic paper to which the invention is applied.

FIG. 3 is a configuration view of a display unit of an electronic paper to which the invention is applied.

FIG. 4 is a device configuration view of a display unit of an electronic paper to which the invention is applied.

FIG. 5 is a block diagram of an electronic paper file to which the invention is applied.

FIG. 6 is a flowchart of an electronic paper file to which the invention is applied.

FIG. 7 is a view showing a status that a connecting terminal of a main unit is fixed to a main unit.

FIG. 8 is a flowchart showing an operation of imparting a connecting-order ID number.

FIG. 9 is a view explaining a method of detecting whether an electronic paper is attached to a connecting terminal of a main unit.

FIG. 10 is a view explaining a method of detecting whether an electronic paper is attached to a connecting terminal of a main unit.

FIG. 11 is a view explaining a method of detecting whether an electronic paper is attached to a connecting terminal of a main unit.

FIG. 12 is an outline view of a main unit under the rotatable configuration.

FIG. 13 is a view showing a method of detecting a position of a connecting terminal of a main unit.

FIG. 14 is a view showing that a photocoupler is provided in a connecting unit.

FIG. 15 is a flowchart showing an operation of imparting a connecting-order ID number.

FIG. 16 is a view showing a status that an intermediate fixing part is used.

FIG. 17 is a view showing that an intermediate fixing part is provided with an element-fixed axis.

FIG. 18 is a view explaining a method of detecting a position of a connecting terminal of a main unit.

FIG. 19 is a view showing an example of an arrangement of a connecting terminal of a main unit.

FIG. 20 is a view showing a shape of a connecting terminal of an electronic paper.

FIG. 21 is a view showing a shape of a connecting terminal of a main unit.

FIG. 22 is an outline configuration view of a main unit under the rotatable configuration.

FIG. 23 is an outline configuration view of a main unit under the rotatable configuration.

FIG. 24 is a block diagram of an electronic paper file to which the invention is applied.

FIG. 25 is a flowchart of an electronic paper file to which the invention is applied.

FIG. 26 is a block diagram of an electronic paper file to which the invention is applied.

FIG. 27 is an outline view of an electronic paper file to which the invention is applied.

FIG. 28 is a view explaining a mark grouping.

FIG. 29 is a block diagram of an electronic paper file to which the invention is applied.

FIG. 30 is a view showing a search example.

FIG. 31 is a view showing a Contents search example.

FIG. 32 is a view showing an Index search example.

FIG. 33 is a block diagram of an electronic paper file to which the invention is applied.

FIG. 34 is an outline view of an electronic paper file to which the invention is applied.

FIG. 35 is a view showing a side face setting menu of an electronic paper file to which the invention is applied.

FIG. 36 is the other configuration view of an electronic paper file to which the invention is applied.

FIG. 37 is the other block diagram of an electronic paper file to which the invention is applied.

FIG. 38 is a diagram showing items displayed when the mark setting system is activated.

FIG. 39 is a view showing a screen displayed when the mark impartation setup item is selected.

FIG. 40 is a configuration view showing an outline of the invention.

FIG. 41 is a view showing a process of creating mark-shape information.

FIG. 42 is a view showing a status that a same mark is indicated on adjoining “Chapters”.

FIG. 43 is a flowchart showing an operation of setting mark-shape information.

FIG. 44 is a conceptual diagram of main data to which mark-shape information is set.

FIG. 45 is a view showing a status that a mark is indicated based on mark-shape information.

FIG. 46 is a view showing a process to avoid an overlap of display ranges of marks.

FIG. 47 is a conceptual diagram of main data to which mark-shape information is set.

FIG. 48 is a view showing a status that a mark is indicated based on mark-shape information.

FIG. 49 is a view showing a method of selecting a display-specified area.

FIG. 50 is a view showing a screen after a display-specified area is selected.

FIG. 51 is a view showing a status that a mark is indicated based on mark-shape information.

FIG. 52 is a flowchart showing a process of creating Contents.

FIG. 53 is a view showing a screen displaying a Contents extraction item.

### BEST MODE FOR CARRYING OUT THE INVENTION

### EMBODIMENT 1

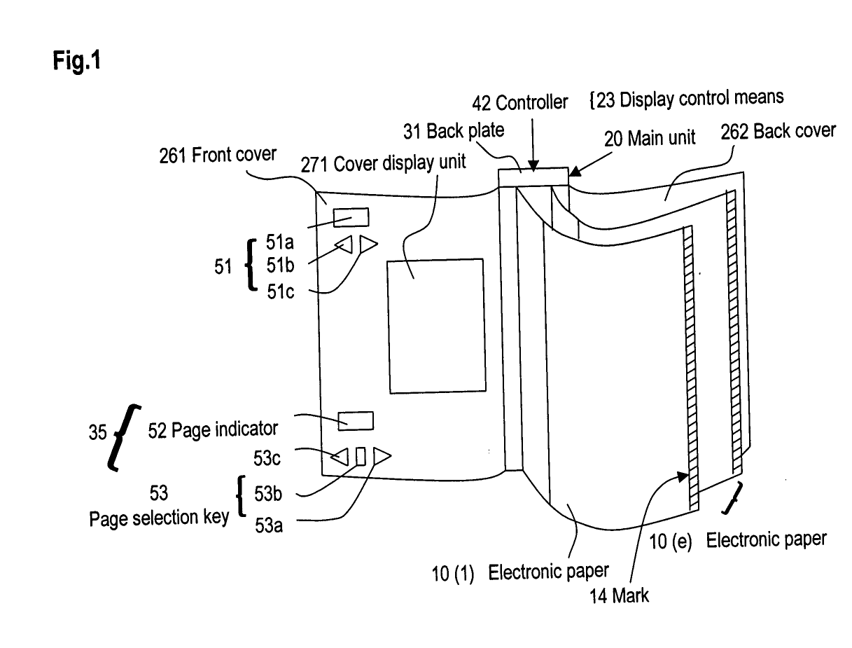

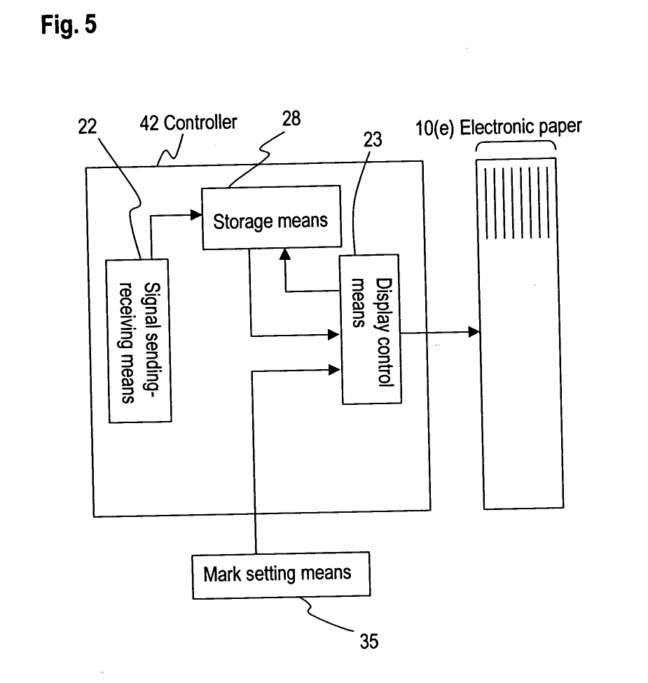

An electronic paper file, to which the present invention is applied, comprises a main unit 20 provided with a front cover 261, a back cover 262, and a back plate 31, and at least an electronic paper 10(e) attached to the main unit 20 removably (e: a positive integer for distinguish an electronic paper from the others), as shown in FIG. 1 and FIG. 5.

The back plate 31 of the main unit 20 is provided with a controller 42 for controlling the display of a specific data and the indication of a mark on the electronic paper 10(e). Under such configuration, the electronic paper 10(e) is designed to display the specific data inputted from outside and indicate the mark described hereinafter.

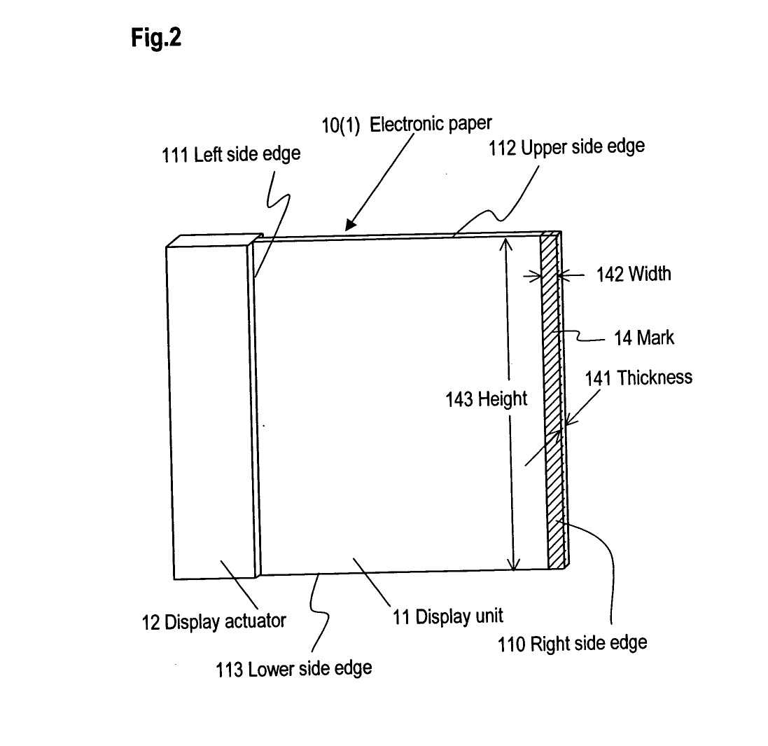

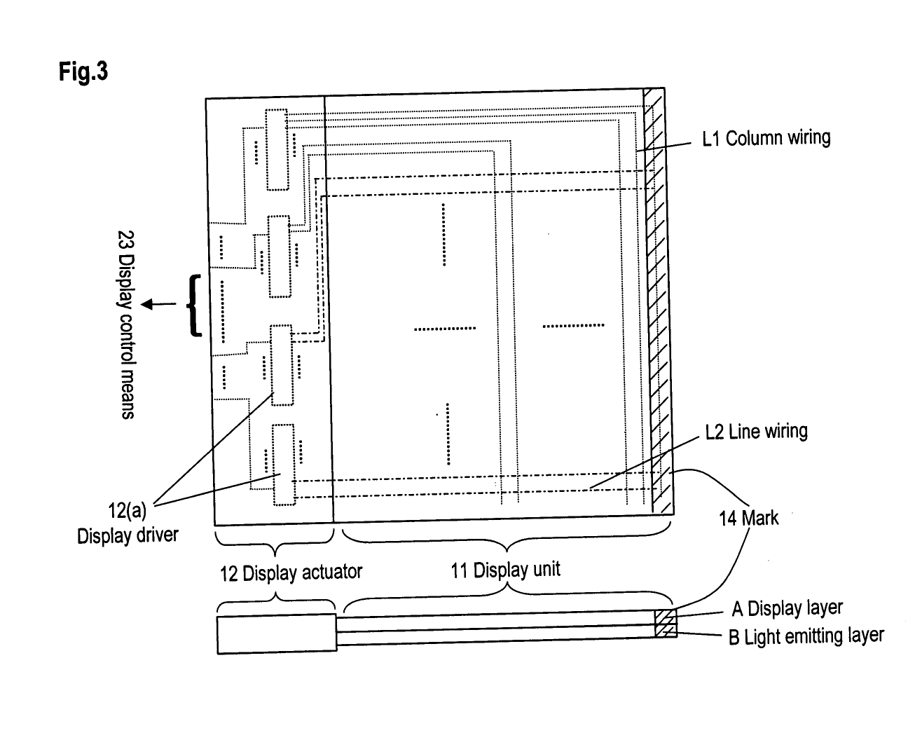

The electronic paper 10(e) shown in FIG. 2 and FIG. 3 comprises a display unit 11 that is a data display area, and a display actuator 12 that is an area for working the display unit 11. And the display unit 11 of the electronic paper 10(e) is designed to display a mark 14 on its side edge.

The side edges of the electronic paper 10(e) shown in FIG. 2 can be defined as a right side edge 110, a left side edge 111, an upper side edge 112, and a lower side edge 113. The right side edge 110 is an edge opposite to the display actuator 12. The left side edge 111 is an edge adjoin to the display actuator 12. The upper side edge 112 is an edge at the top of the display unit 11. The lower side edge 113 is an edge at the bottom of the display unit 11.

The one that described as only “side edge” hereinafter indicates the right side edge 110. Accordingly, as shown in FIGS. 1 to 3, only the right side edged 110 is marked by a hatching regardless of the left side edge 111, the upper side edge 112 and the lower side edge 113.

The size of mark 14 is expressed with a thickness 141, a width 142, and a height 143. The thickness 141 of the mark 14 is equal to the thickness of the display unit 11. In FIG. 2, the width 142 of the mark 14 corresponds to a length in the line direction of the mark 14, and the height 143 corresponds to a length in the column direction of the mark 14.

The mark 14 adopted by the invention may be the one that the user can recognize through his eyes, and the embodiment is not limited to the above. That is to say, the mark 14 may be displayed not only the right side edge 110 of the display unit 11, but also anyone of the left side 111, the upper side edge 112, and the lower side edge 113. The size of the mark 14 is not limited to the one shown in FIG. 2.

The controller is provided with a signal sending-receiving means 22, a display control means 23, and a storage means 28, as shown in FIG. 5. The signal sending-receiving means 22 receives an electronic data of characters and images sent from the other electronic paper or a personal computer, and stores such electronic data in the storage means 28 as a data to be displayed on the electronic paper 10(e) (said data is called “main data” hereinafter).

The display control means 23 sends to each electronic paper 10(e) the main data thus stored in the storage means 28.

As the storage means 28, the invention can adopt an IC memory built n the main unit 20, or a storage medium such as an IC card or the like. The storage means 28 may be provided no to the controller 42, but to each electronic paper 10(e).

The display control means 23 controls, in accordance with after-mentioned mark information, the indication of the mark corresponding to the page number or the paragraph number displayed on the display unit 11 of each electronic paper 10(e). The display control means 23 manages each electronic paper 10(e) correlated with the page number displayed on the electronic paper 10(e). In order to manage in such way, information of the ID number of the electronic paper (which is called the “electronic paper number” hereinafter) and the page number of main data is stored in the storage means 28.

Besides, the management of the electronic paper 10(e) may be performed by the other means provided in the controller 42 instead of the display control means 23. That is to say, the display control means 23 performs only a simple display control, and the other control means may perform the processing like the management of the electronic paper 10(e) that is not regarded as an essential display control. Then there are occasions when the display control means 23 for controlling the indication of the mark is called a “mark indication control means” particularly.

The mark data contains information of the mark indication position and the mark color. The mark data is created by an after-mentioned mark setting system, which is stored in the storage means (not shown) in a mark setting means 35. It is needless to say that the mark data may be stored not in the storage means of the mark setting means 35 but in the storage means 28.

The mark setting means 35 is provided with a function of selecting a desired main data from the main data stored in the storage means 28 (for instance, page 201 of an encyclopedia). The main data thus selected is sent to the display control means 23 together with the corresponding mark data.

The mark data to be sent to the display control means 23 may be obtained from the storage means of the mark setting means 35. The mark setting means 35 may send to the display control means 23 the information capable of specifying main data (for instance, information of the page number or the paragraph number, and etc.) instead of the above-mentioned main data.

The mark setting means 35 comprises page selection keys 53 for selecting a desired page, and a page indicator 52 for indicating the page number selected by the page selection key 53. The page selection keys 53 are composed from a backward key 53a, an enter key 53b, and a forward key 53c.

FIG. 1 shows a configuration that the mark setting means 35 is installed to the front cover 261, but the mark setting means 35 may be installed to the back cover 262. The mark setting means 35 is designed so as to comprise a plurality of keys, but a method carrying out the mark setting means 35 is not limited to this. For instance, a desired page may be selected by using a menu displayed on a front display unit 271 and a keyboard separately connected with the main unit 20, in such case it is possible to obtain the same effect.

The mark setting means 35 may be provided to each electronic paper 10(e). In this case, the display unit 11 of the electronic paper 10(e) is provided with a function such as a digitizer or a touch panel. Accordingly, if a user wants to display the mark 14 on the electronic paper 10(e), the user touch the display unit of the electronic paper displaying his desired page with his hand or a writing device, with the result that the page can be selected.

But the mark setting means 35 does not always select a page. As described later, the mark setting means 35 may be designed so as to select character strings included in a page.

The display control means 23 stores in advance the main data received from the mark setting means 35 (in this case, the page number and the mark data) in the storage means (not shown) of the display control means 23. When the page corresponding to thus stored page number is displayed on the electronic paper, the display control means 23 controls the indication of a mark on the electronic paper, said mark corresponding to the page number according to the mark data.

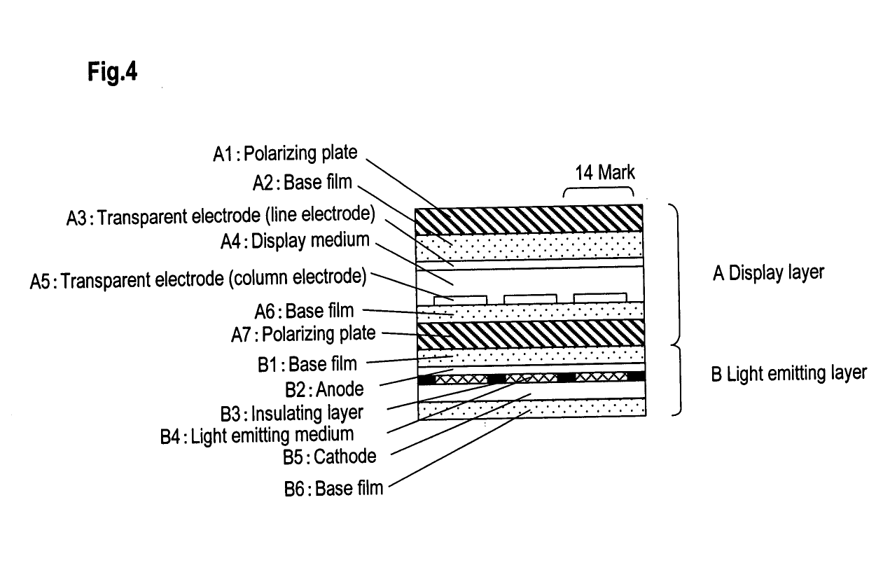

The display unit 11 of the electronic paper comprises a display layer A provided with a specific display medium and a light emitting layer B illuminating the display layer A, as shown in FIG. 4, of which configuration is explained as follows.

A transparent electrode of an ITO (a line electrode) A3, for example, is formed on an upper side base film A2, and a transparent electrode of an ITO (a column electrode) A5, for example, is formed on a down side base film A6. Additionally, a display medium (a ferroelectric high polymer liquid crystal, for example) A4 is applied in a specific thickness over the column electrode A5. Next, the line electrode A3 and the column electrode A5 are facing mutually and bonded so as to be lattice-like. Then, molecules of the display medium A4 are oriented in a specific direction. After that, they are bonded so as to insert them between polarizing plates A1 and A7. In result, the display layer A is formed.

On the other hand, the light emitting layer B is formed so as to make the whole surface emit light uniformly. Specifically, an anode B2 composed from a transparent electric conductor is formed on an upper side base film B1, a cathode B5 composed from a metal is formed on a down side base film B6, and a light emitting medium (organic electro luminescence, for example) B4 is formed in a specific pattern on the cathode B5 by using a insulating layer B3. After that, the anode B2 and the cathode B5 are bonded so as to face mutually in a lattice-like. Accordingly, the luminous layer is formed.

Finally, the light emitting layer B formed as above is boned to the down side of the display layer A so that the light emitting layer B may illuminate the display layer A.

The displaying of the display layer A is controlled by the matrix control utilizing a following shutter function. That is to say, when a specific voltage (a positive voltage) is impressed between the line electrode A5 and the column electrode A3 of the display layer A, molecules of the display medium A4 change the orientation to the direction not transmitting light (the shutter is ON), and thereby the pixels specified by the line electrode A5 and the column electrode A3 are displayed in black. On the other hand, when the voltage reverse to the specific voltage (a negative voltage) is impressed, the molecules of the display medium A4 change the orientation to the direction transmitting light (the shutter is OFF), and thereby those pixels are displayed in white.

On the other hand, when the voltage is impressed between the anode B2 and the cathode B5 of the light emitting layer B, the whole surface-of the light emitting medium B4 emits light and illuminates the display layer A. That is to say, when the light emitting medium B4 emits light, the white pixels transmitting this light (said pixels wherein the shutter are OFF) are lighting.

Besides, if the anode B2 and the cathode B5 of the light emitting medium B4 are changed to lattice-like distinctive electrodes (that is to say, the line electrode and the column electrode) and the voltages to be impressed is changed per distinctive electrodes, it becomes possible to illuminate only a region to be emphasized, such as a title region.

Additionally, in case of making the light emitting layer B emit light in mono-color, a monochromatic light source may be placed on the whole surface of the layer uniformly. On the contrary, in case of making the light emitting layer B emit light in full-color, RGB (Red, Green, and Blue) light sources may be placed on the whole surface of the layer in lattice-like. Even in case of full-color, if it is necessary to make the whole surface of the layer emit light in a uniform color and luminance, it is sufficient that the anode B2 and the cathode B5 are provided to the light emitting layer B instead of the distinctive electrodes.

The control of the display layer A is performed by the display control means 23 of the controller 42. And the control of the light emitting layer B is performed by the light emitting control means (not shown) of the controller 42.

The mark 14 is indicated by using specific pixels of lines included in the right side edge 110 of the display unit 11. That is to say, at least one pixel of a line included in the right side edge 110 of the display unit 11 is lighted or blinked, so that the mark can be lighted or blinked.

Additionally, the mark 14 is indicated in a specific color when the light emitting layer B emits light in full color. Moreover, when the pixels composing the mark 14 increase in number and the lighting or blinking is controlled per pixel, the mark 14 can display characters and images.

Besides, it is needless to say that forming the anode B2 and the cathode B5 in a lattice-like distinctive electrode and changing the voltage on or off, to be impressed on each electrode make it possible to illuminate only a part of the display unit 11, for example, the right side. When a nonvolatile transparent liquid crystal, which is different in the orientation characteristics from the display medium A4 of the display layer A, is used as a display medium to a section corresponding to the mark 14, the mark 14 is indicated clearer.

The configuration of the display actuator 12 of the electronic paper 10(1) is exemplified as follows.

As shown in FIG. 3, the display actuator 12 is provided with a display driver 12(a) comprising a plurality of semiconductor chips (a: a positive integer for distinguishing a display driver from the other).

The semiconductor chip composing the display driver 12(a) is connected with column wirings L1 and line wirings L2. The column wiring L1 is a wiring between the column electrode A5 of the display layer A and the display driver 12(a), and the line wiring L2 is a wiring between the line electrode A3 of the display layer A and the display driver 12(a). The display driver 12(a) and the display control means 23 of the main unit 20 are connected through a connecting terminal through a 8-bit bus, for example. The display driver 12(a) decodes a 8-bit signal transferred through the bus from the display control means23, and impresses a specific voltage on the line electrode A3 and the column electrode A5 specified by the 8-bit signal (the number of respective line and column electrodes is many more numbers than “8”). Therefore, providing the electronic paper side with the display driver 12(a) has a merit that it is possible to reduce the number of pins of the connecting terminal.

As described above, the display control means 23 controls the indication of the mark 14 on each electronic paper 10(e) according to the mark data included in the main data, as well as controls the display of the main data stored in the storage means 28 on each electronic paper 10(e). That is to say, the display control means 23 sends out the main data (including the mark data) per data corresponding to one pixel as a specific bit data, for example, the 8-bit data.

The specific 8-bit data comprises an address of each pixel together with voltage information, said information indicating whether either the positive or the negative voltage should be impressed on respective line electrode A3 and column electrode A5 corresponding to each pixel. The invention presupposes that the main data is a binary dot data. However, if the main data is in the ASCII format, the Binary format, or the like, the display control means 23 may convert said data to the binary dot data.

The display driver 12(a) of each electronic paper 10(e) decodes the main data sent from the display control means 23. And the voltage corresponding to the decoded data is outputted to the line wiring L1 and the column wiring L2 corresponding to the address.

The voltage information comprises “0” indicating that the positive voltage is impressed respectively on the column electrode A3 and the line electrode A5 corresponding to each pixel, “1” indicating that the reverse voltage is impressed respectively on the column electrode A3 and the line electrode A5 corresponding to each pixel, and “NON” indicating that no voltage is impressed respectively on the column electrode A3 and the line electrode A5 corresponding to each pixel.

Said “NON” is the voltage information of the address of pixel not to be accessed. For instance, when the user writes additional items onto the display layer A by means of the digitizer (otherwise, when he corrects the content), only the pixels included in the region in which the additional items are written (or the pixels included in the region in which the correction is made) may be accessed. That is to say, it is not necessary to access the pixels included in the region in which no additional items is written (or the pixels included in the region with no correction), therefore, “NON” is set to such pixels as the voltage information.

Besides, the number of semiconductor chips used as the display driver 12(a) is not limited particularly. In addition, the wiring method of the display driver 12(a), and the column electrode A5 and the line electrode A3, is not limited to the above.

Moreover, as shown in FIG. 3, the display actuator 12 may be thicker than the display unit 11. The member of the display actuator 12 may be larger in Young's module than the display unit 11.

Furthermore, it is explained in the above that each electronic paper is provided with the display actuator 12, but the invention is not limited to such configuration. That is to say, it may be arranged that the display control means 23 of the main unit 20 is provided with the display driver 12(a), and the display control means 23 is connected with the column wiring L1 and the line wiring L2.

Now, in the invention, when the main data displayed on the electronic paper 10(e) is edited, the mark 14 can be indicated together with the edited main data. For example, when a character string, “Chapter 1”, is inputted by any method, the electronic paper displaying the character string “Chapter 1” can be made to indicate the mark 14.

And, in the invention, it is possible to attach to the electronic paper a “mark equivalent to a sticky note” for a user's memorandum. In this case, as the region to attach the mark 14 thereto, the whole of the right side edge 110 may be used. Otherwise, in consideration for displaying the mark together with the edited main data, only a specific part of the right edge 110 (an upper right corner, for example) may be used as the region.

The following is an example of the mark setting procedure by the mark setting means 35. The explanation presupposes that three electronic papers 10(1) to 10(3) are attached to the main unit 20, and the storage means 28 stores the main data for pages that cannot be displayed on the three electronic papers.

First, the user operates a display console 51 for displaying the main data for pages 201 to 203 on the electronic papers 10(1) to 10(3). The display console 51 comprises a page indicator 51a, a forward key 51b, and a backward key 51c, which are described hereinafter.

That is to say, the page indicator 51a indicates the page number of the main data displayed on the electronic paper (in case of a plurality of electronic papers, the page number of the main data displayed on the first electronic paper). The forward key 51b puts a page of the main data displayed on the electronic paper forward one page. The backward key 51c puts a page of the main data displayed on the electronic paper backward one page.

In such way, the user operates the display console 51 and hereupon the main data for pages 201 to 203 are displayed on the electronic papers 10(i) to 10(3). At this time, the display control means 23 controls the indication of the page number “201” on the page indicator 52. The page indicator 52 is separated from the page indicator 51a provided to the display console 51, and is an indication unit for imparting the mark. The page indicator 52 displays the page number of the main data displayed on the first page that is an open sheet of the electronic papers.

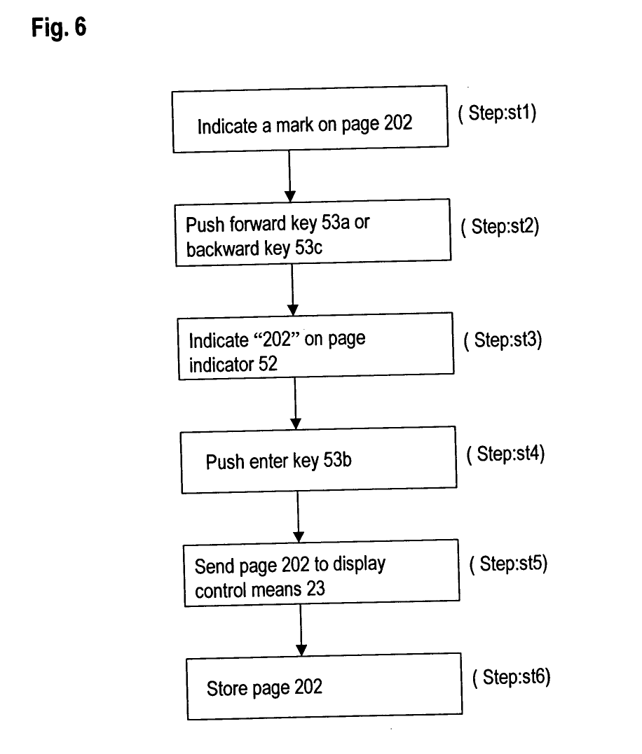

When the user wants to indicate a mark on a part that he found on page 202 (FIG. 6, Step: st1 to st2), he pushes the forward key 53a of the mark setting means 23 one time (FIG. 6, Step: stl to st3). And hereby, the page number “202” is indicated on the page indicator 52 (FIG. 6, Step: st3 to st4).

Next, the user pushes the enter key 53b (FIG. 6, Step: st4 to st5), hereupon the mark setting means 35 gives the display control means 23 the information indicating page 202 (which is described as “202” only) (FIG. 6, Step: st5 to st6). As well as the “202”, the mark setting means 35 gives the display control means 23 an instruction to indicate the mark on a page corresponding to “202” (Page 202) together with a specific mark data.

The display control means 23 correlates the received mark data and “202”, and then stores them in the storage means provided to the display control means 23 (FIG. 6, Step: st6). The above-mentioned processing of storing the main data (Page 202) correlated with the mark data in the storage means of the display control means 23 is defined as “set” hereinafter.

Now, the display control means 23 manages each electronic paper 10(e) correlated with the numbers of the pages displayed on each electronic paper 10(e). Therefore, on receiving from the mark setting means 35 the instruction to indicate the mark on page 202, the display control means 23 searches the page numbers of the main data and the correlated electronic paper numbers that are managed by itself. As a result of this searching, when it is decided that the display control means 23 manages page 202, the display control means 23 controls the indication of the mark based on the mark data corresponding to “202” on the electronic paper displaying page 202.

When the user also wants to display the mark on a page not displayed currently on the electronic paper (page 199, for example), he pushes the enter key 53b while he makes the page indicator 52 indicate “199” by operating the backward key 53c. Hereby, the mark setting means 35 gives the display control means 23 a specific mark data and “199”.

Hereupon, the display control means 23 stores in the storage means of the display control means 23 the received mark data and “199”, in such way as described above. In this case, too, the display control means 23 searches the page numbers of the main data and the electronic paper numbers managed by itself based on the page of “199”. As a result of this searching, when it is decided that the currently displayed pages are 201 to 203 (that is to say, page 199 is not displayed), accordingly the display control means 23 does not control the indication of the mark based on the mark data corresponding to “199”. However, when the user displays page 199 on either electronic paper by means of the display console 51, the mark is indicated based on the mark data corresponding to “199”.

When the user wants to cancel the mark set on a specific page, the cancel instruction (giving a long push to the enter key 53b) may be executed while the page number to be a cancel object is displayed on the page indicator 52. Hereby, the mark setting means 35 gives the display control means 23 the instruction of canceling the mark set and the page number to be cancelled. And the display control means 23 updates the content of the storage means so as to cancel the mark setting displayed on the page.

The above description exemplifies a configuration that a console for setting a mark is separated from a console for displaying the main data, however, the invention is not limited to this. That is to say, the forward key and the backward key of the display console 51 can be used as the console for setting the mark.

In this case, a page to be a mark set target is set to the first electronic paper, for example. And when the user pushes the enter key 53b while the page to be the mark set target is displayed on the first electronic paper, the mark is set to the electronic paper. On the other hand, the user gives long push to the enter key 53b when the electronic paper displays the page of which the setup of mark is cancelled. Then the mark set on the electronic paper is cancelled. In case of adopting such configuration, it comes to be impossible to set or cancel a mark regardless of a currently displayed page, but there is an effect that it is possible to reduce the number of keys.

In addition, the invention presupposes in the above description that there is one position where one electronic paper can indicate the mark. But the invention is not limited to this. That is to say, one electronic paper may be provided with a plurality of position indicating a mark. In case of adopting such configuration, another means is required for determining the position indicting the mark. It is possible to use the enter key 53b as said means, for example. That is to say, in case where the enter key 53b is given a short push, said plural mark position becomes active one after another in the sequential order from the top. And when the mark position that the user wants to indicate the mark to be active, the user gives a long push to the enter key 53b, and thereby the mark can be set to be indicated on that position.

According to this embodiment described above, it is possible to indicate a mark on an electronic paper displaying specific character strings, and to cancel the set of said mark in a simple operation. It is needless to say that said mark could be used as a sticky note or a bookmark, and being classified into specific groups per page unit.

The control of the indication of a mark on each electronic paper 10(e) does not need to be performed by the display control means 23 only, but a specific means for said control may be provided separately. Besides, in such case, the specific means performs the control of the indication of the mark based on the electronic paper numbers managed by the display control means 23.

This embodiment exemplifies a configuration that the main unit 20 is provided with the storage means 28, the display control means 23, and the mark setting means 35, but the invention is not limited to this configuration. In case where the invention is configured so that the electronic paper is provided with the storage means 28, the display control means 23, and the mark setting means 35, it is possible to carry out the set of the mark like the above only by the electronic paper, only its unit.

### EMBODIMENT 2

Now, a connecting terminal is provided to the main unit 20 and the electronic paper 10 (those are a pair of connecting terminals, for example), and can connect the main unit 20 and the electronic paper 10 physically and electrically. It is needless to say that, even if the connection is not established physically, the display unit 11 can display characters corresponding to the main data when the electrical connection is established. In order to establish the electrical connection, both the main unit 20 and the electronic paper 10 may be provided with the wireless communication function (a communication function matching to IRDA, Bluetooth, for example).

The electronic paper 10 of the invention can be removed from the main unit 20. In order to transfer the main data to only the connecting terminal 25 connected with the electronic paper, an attachable detecting means 60 may be provided to the main unit 20 as described hereinafter.

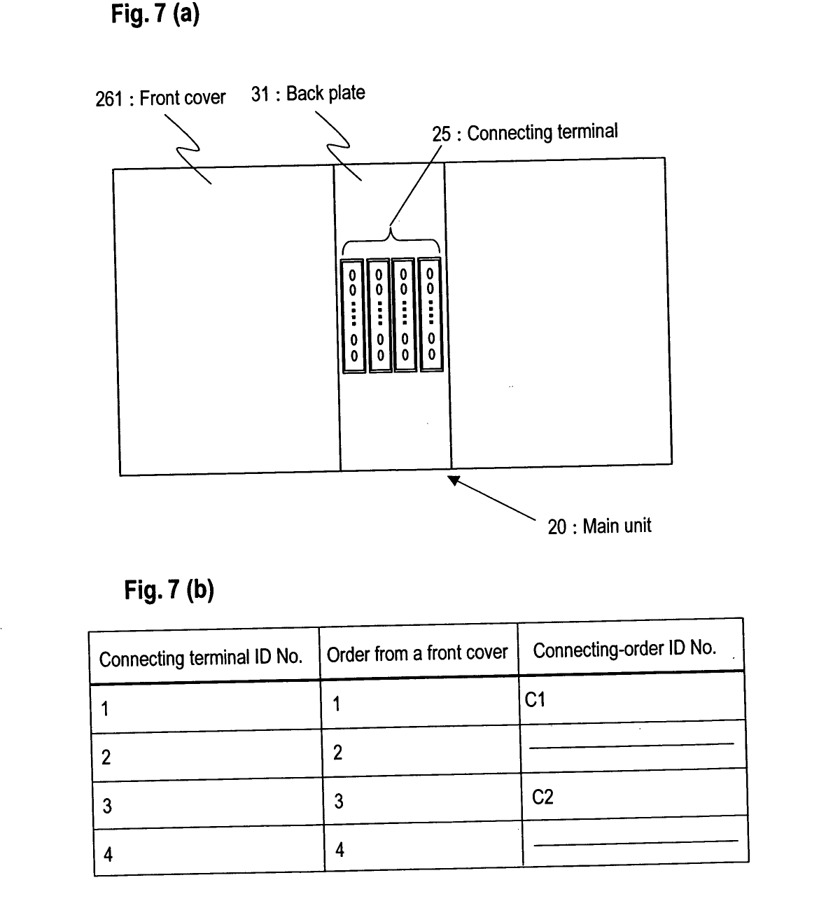

As shown in FIG. 7(a), the connecting terminal 25 of the main unit 20 is placed and fixed to a specific position of the main unit 20. The storage mans 28 stores the numbers (connecting terminal No.) indicating respective connecting terminal of the main unit 20 along with the arrangement order.

The impartation of allocating the connecting terminal numbers is not limited in particular, but the number may be imparted so as to become larger as getting away from the front cover 261 of the electronic paper file. That is to say, as shown in FIG. 7(b), the connecting terminal 25 on the nearest position to the front cover 261 is imparted with an ID No.1, the connecting terminal 25 on the second nearer position to the front cover 261 is imparted with an ID No. 2, the connecting terminal 25 on the third nearer position to the front cover 261 is imparted with an ID No. 3, and the connecting terminal 25 on the fourth nearer position to the front cover 261 is imparted with an ID No. 4.

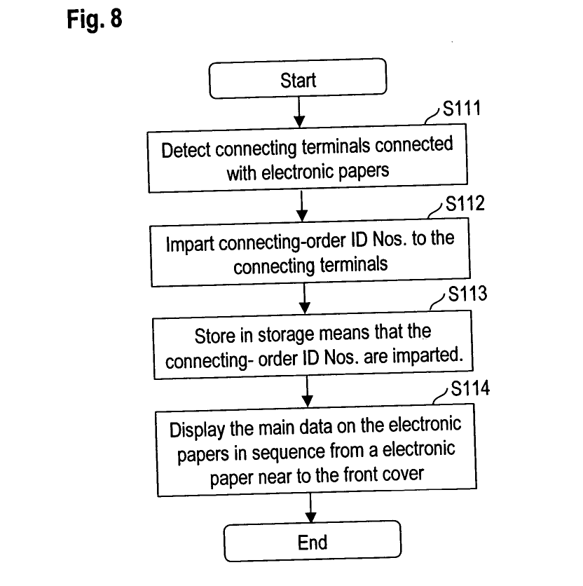

When the attachment detecting means 60 detects the connecting terminal to which the electronic paper 10 is attached, the ID number of the detected connecting terminal is obtained from the storage means 28 (FIG. 8, S111). For instance, when the connecting terminal with the ID No. 1 and the connecting terminal with the ID No. 3 are connected with the electronic papers respectively, the attachment detecting means 60 obtains the ID Nos. 1 and 3 from the storage means 28.

And the attachment detecting means 60 imparts the numbers indicating the connecting order (the connecting-order ID No.) to the connecting terminals with the ID Nos. 1 and 3 with (FIG. 8, S112). In this case, the connecting terminal 25 nearest to the front cover 261 (the connecting terminal 25 with the connecting terminal ID No. 1) and the connecting terminal 25 the third nearer to the front cover 261 (the connecting terminal 25 with the connecting terminal ID No. 3) are attached with the electronic papers. Therefore, the attachment detecting means 60 imparts the connecting-order ID No. C1 to the connecting terminal 25 of the connecting terminal ID No. 1; the connecting order ID No. C1 indicating that the attached electronic paper is the nearest to the front cover 261. And at the same time, the connecting-order ID No. C2 indicating that the attached electronic paper 10 is the second nearer to the front cover 261 is imparted to the connecting terminal 25 with the connecting terminal ID No. 3.

The attachment detecting means 60 stores in the storage means 28 that the connecting-order ID Nos. C1 and C2 are imparted to the connecting terminals 25 as above (FIG. 8, S113) as well as notifies the display control means 23 of the connecting-order ID Nos. The display control means 23 receives the notification and transfers the main data to the connecting terminals 25 with the connecting terminal ID Nos. 1 and 3. Accordingly, since it does not occur that the main data is sent to the connecting terminal attached with no electronic paper (without the display leakage), the main data can be displayed on the electronic paper in sequence from the electronic paper nearer to the front cover (FIG. 8, S114).

The above describes that the connecting-order ID number is imparted to the connecting terminal, however, the method of imparting the connecting-order ID number is not limited to this. For example, when the storage means stores the connecting terminal ID Nos. 1 to 4, flags are placed on storage areas corresponding to only the connecting terminal ID Nos. 1 and 3 of the connecting terminals 25 to which the electronic papers are attached. Thereby, it is possible to regard that the connecting-order ID No. C2 is imparted to the connecting terminal 25 with the connecting terminal ID No. 3 as well as the connecting-order ID No. C1 is imparted to the connecting terminal 25 with the connecting terminal ID No. 1.

The following explanation relates to a configuration that the attachment detecting means 60 detects the connecting terminal to which the electronic paper 10 is attached.

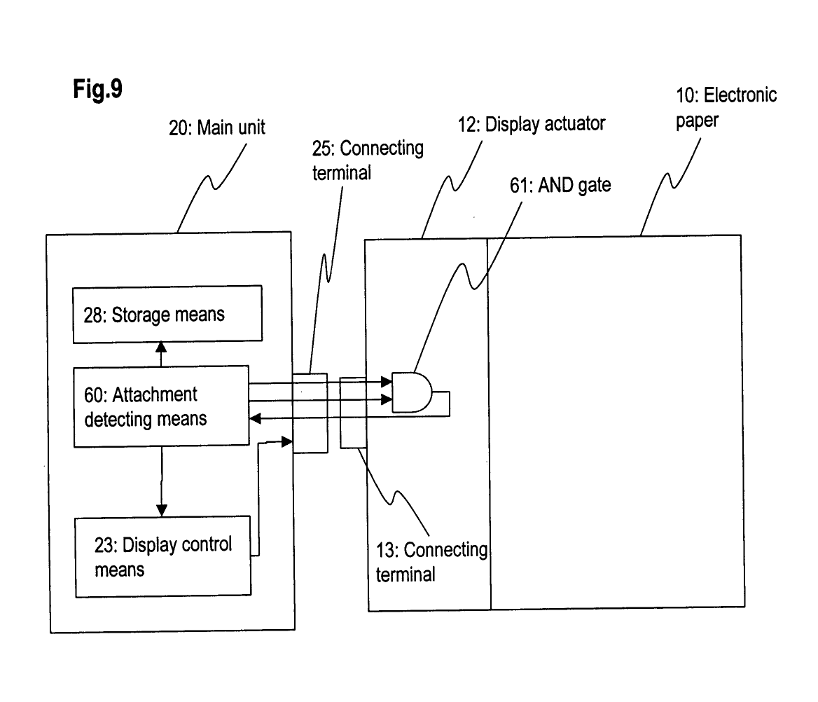

As shown in FIG. 9, the main unit 20 is provided with the attachment detecting means 60, and two “1” -signals are outputted from the attachment detecting means 60 to each connecting terminal 25. At this time, if the electronic paper 10 is attached to the connecting terminal 25, the two “1” -signals are inputted to an AND gate 61 of the display actuator 12 of the electronic paper through the connecting terminal 13 of the electronic paper. And the AND gate 61 sends back the “1” -signals to the attachment detecting means 60 thought the connecting terminals 13 and 25. Accordingly, the attachment detecting means 60 can detect that the electronic paper 10 is attached to the connecting terminal 25 from which the electric signals are outputted.

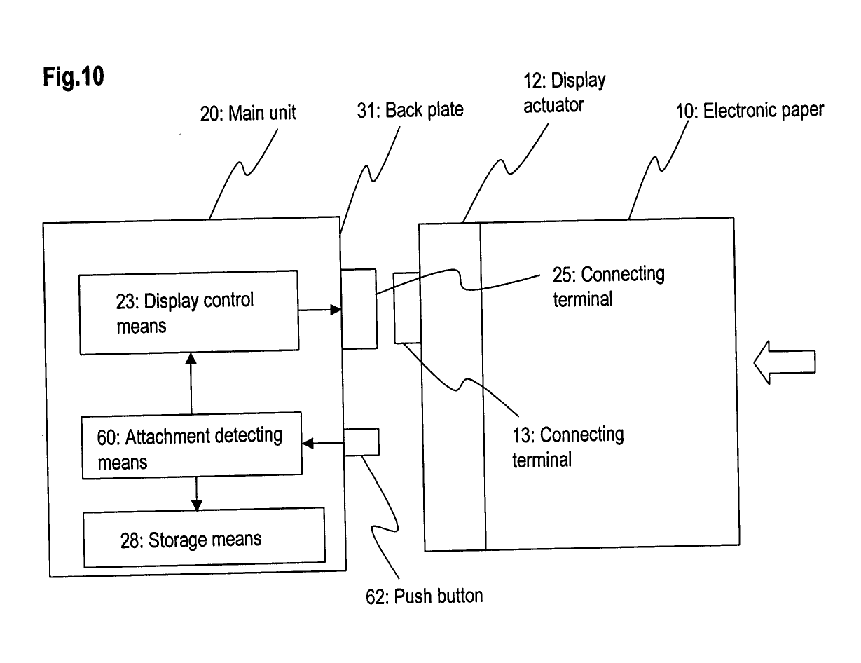

Also in the configuration shown in FIG. 10 that a push button 62 is provided on the inside face of the back plate 31 of the main unit 20, it is possible to obtain the same effect as above. That is to say, when the electronic paper 10 is attached to a specific connecting terminal 25, the push button 62 is pushed down by the electronic paper 10 simultaneously. Thereby, the attachment detecting means 60 can detect that the electronic paper 10 is attached to the specific connecting terminal.

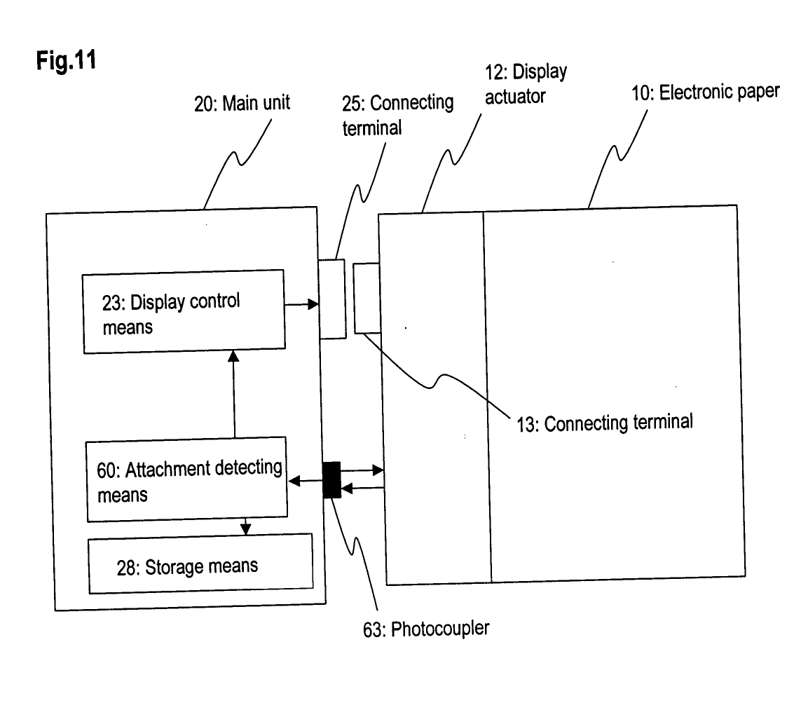

Otherwise, as shown in FIG. 11, a photocoupler 63 is provided to the main unit 20 so as to emit light in the projecting direction of the connecting terminal 25, and according to the reflected light volume the attachment detecting means 60 may detect whether the electronic paper is attached or not. In other words, when the electronic paper is attached to the connecting terminal, the light emitted from the photocoupler 63 is reflected by the electronic paper 10. Accordingly, the attachment detecting means 60 recognizes that the photocoupler 63 receives a specific volume of the reflected light, and then detects that the connecting terminal 25 is attached with the electronic paper 10.

In the above configuration, the connecting terminal 25 of the main unit 20 is fixed to the back plate 31. But the connecting terminal 25 is very useful if it is rotatable as follows.

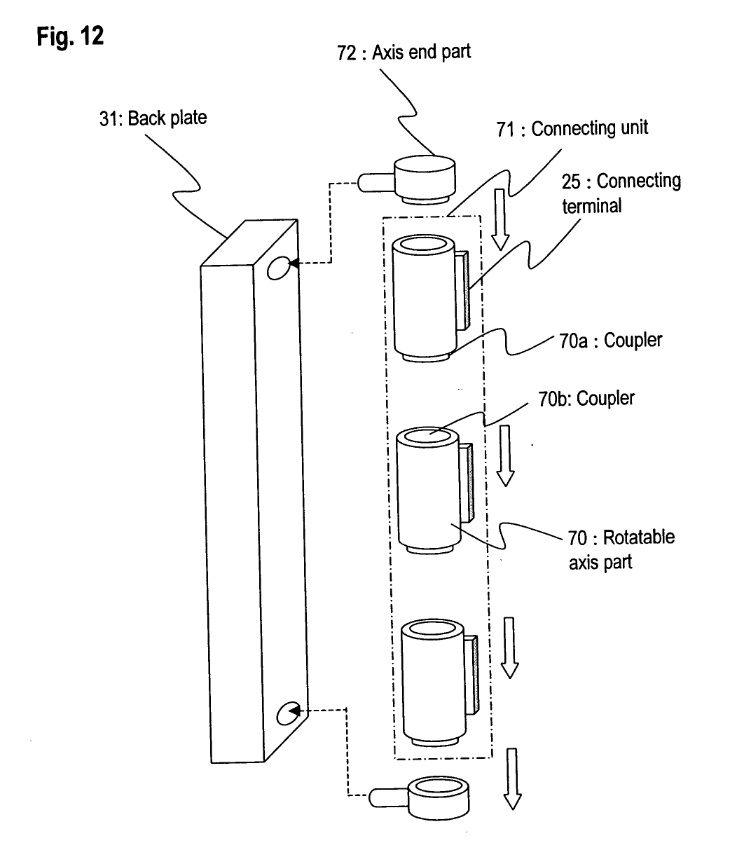

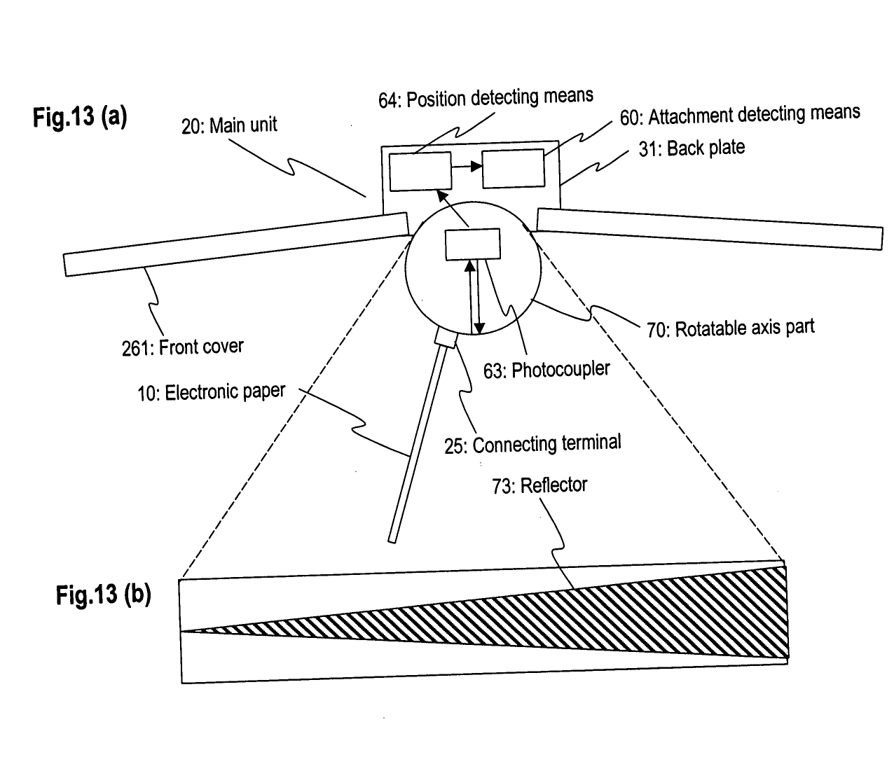

In a configuration shown in FIG. 12, a cylindrical rotatable axis part 70 in a specific length is provided at both upper and bottom ends thereof with couplers 70a and 70b that can be connected rotatably with the other rotatable axis part 70. The rotatable axis part 70 is provided on the inside periphery with a reflector 73 of which width gets narrow in the circumference direction, as shown in FIG. 13(b). And the rotatable axis part 70 is provided in the direction of the outside periphery with the connecting terminal 25 of the main unit. And by connecting such configured rotatable axis parts 70, a connecting unit 71 can be formed.

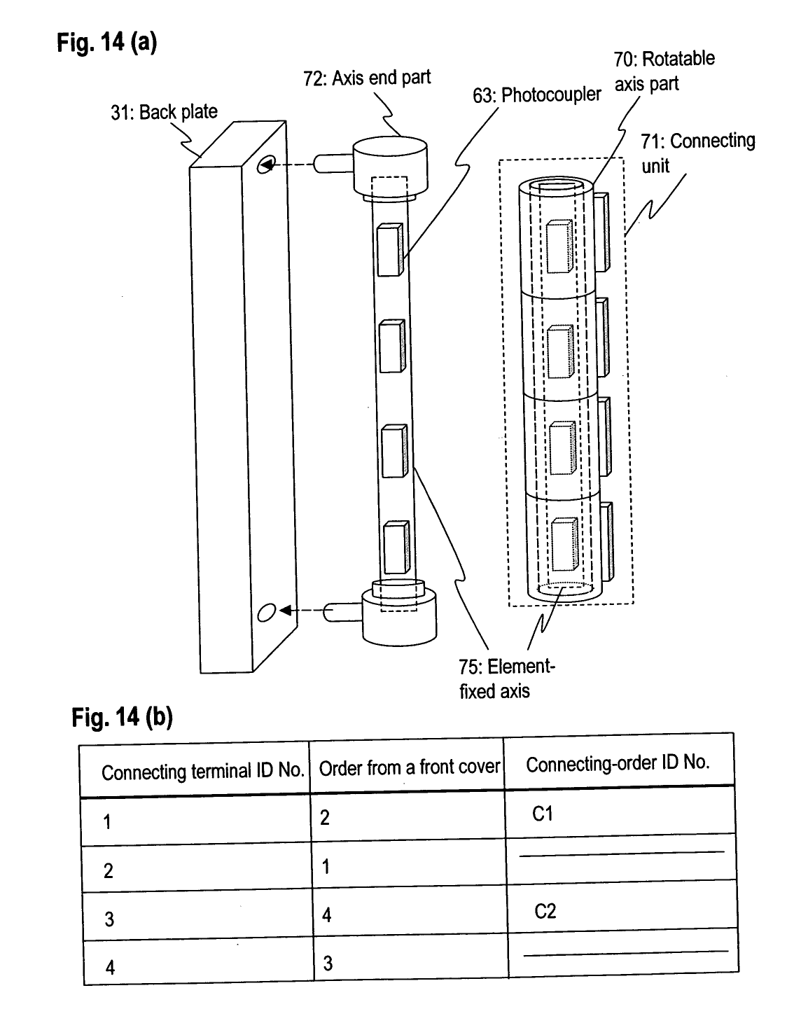

On the other hand, the photocoupler 63 shown in FIG. 14 is fixed to an element-fixed axis 75 within the rotatable axis part 70 so as to face to the reflector 73. Additionally, the element-fixed axis 75 is fixed to an axis end part 72 in the status of being installed into the connecting unit 71. The axis end parts 72 are connected rotatably with the upper and bottom ends of the connecting unit 71, and also fixed to the inside face of the back plate 31. Besides, the methods of fixing the axis end part 72 to the inside face of the back plate 31 and fixing the both ends of the element-fixed axis 75 to the both ends of the axis end part 72 are not described here in detail because they are not essential of the invention.

When the connecting unit 71 is attached to the back plate 31 as above, each photocoupler 63 emits light in the same direction. And at this time, in case where the connecting terminals 25 attached to each rotatable axis part 70 is made to be oriented to the same direction, the reflector 73 provided to the inside periphery of each connecting terminal indicates the same width in the axis direction along the inside periphery. Thereby, it is needless to say that the photocoupler 63 outputs signals corresponding to the rotation angle of each rotatable axis part 70 (the rotation angle of each electronic paper 10).

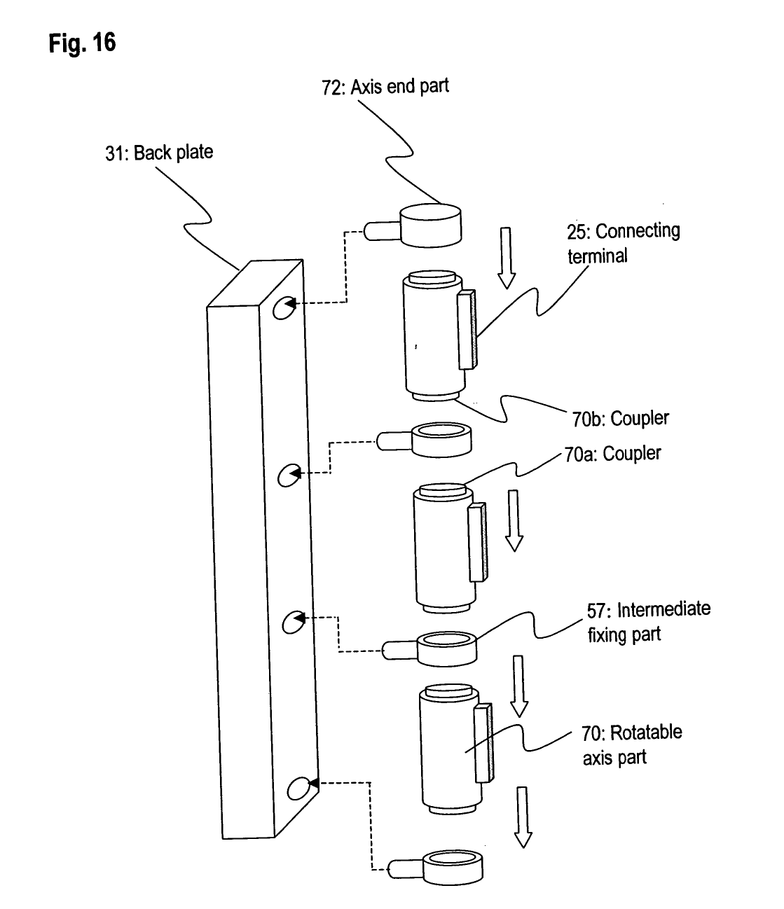

In the above configuration, each rotatable axis part 70 is connected each other directly. But, as shown in FIG. 16, if an intermediate fixing part 76 is intervened between the rotatable axis parts 70, the connecting unit can be attached more stably to the back plate 31.

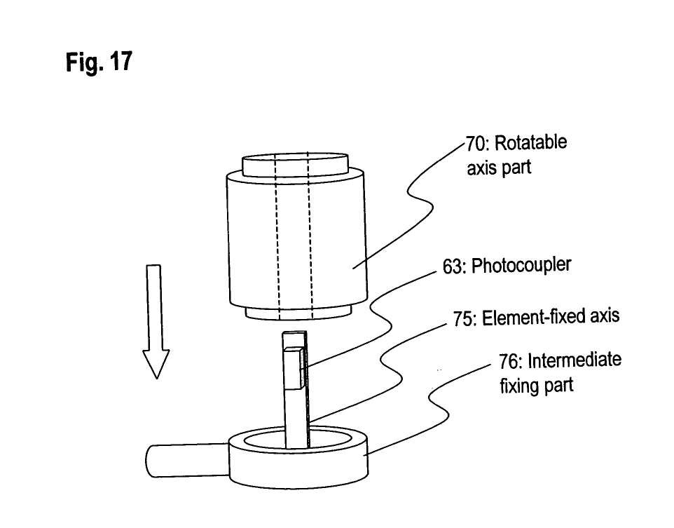

Specifically, the couplers 70a and 70b of each rotatable axis part 70 are inserted rotatably to the intermediate fixing parts 76, and this forms the connecting unit 71 comprising these rotatable axis parts 70. The connecting unit 71 is fixed to the back plate 31 by the intermediate fixing part 76 as well as by the axis end part 72 like the above. In this case, the element-fixed axis 75 may be configured in the same way as the above (see FIG. 14), or so as to project from each intermediate fixing part 76 or the axis end part 72 toward the inside of each rotatable axis part 70, as shown in FIG. 17.

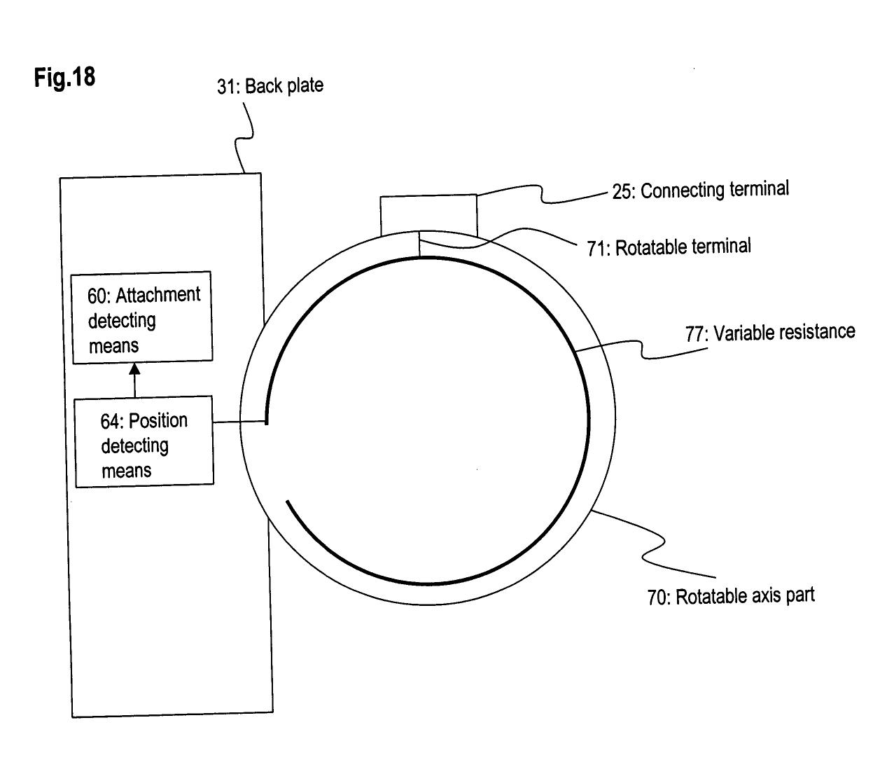

When a variable resistance 77 is substituted for the photocoupler 63 as shown in FIG. 18, it can be obtained the rotation angle of each electronic paper. That it to say, the doughnut-shaped variable resistance 77 is fixed to the element-fixed axis 75 so as not to disturb the revolution of the rotatable axis part 70, and a rotatable terminal 71 contacting this doughnut-shaped variable resistance 77 is provided to the inside face of each rotatable axis part. Under such configuration, at the time of revolving a specific connecting terminal, the variable resistance 77 indicates the voltage corresponding to the rotation angle, in result the rotation angle of each electronic paper can be obtained.

It is designed in the above description that the reflector 73 is provided to the inside periphery of the rotatable axis part 70, but the invention is not limited to this. When the rotatable axis part 70 is made of a transparent material, it is possible to obtain the same effect by providing the reflector 73 to the outside periphery of the rotatable axis part 70.

When the rotation angle of each connecting terminal 25 of the main unit can be obtained by using the photocoupler or the variable resistance as mentioned above, the rotation angle is to be informed to the attachment detecting means 60 by a position detecting means 64 of the main unit 20. Thereby, after detecting the connecting terminal attached with the electronic paper 10, the attachment detecting means 60 imparts the connecting-order ID number to the detected connecting terminal 25 based on the information. Such operation is explained hereinafter in detail.

Besides, the following explanation is based that the connecting terminal ID No. 1 is for the connecting terminal 25 at the nearest position to the topside of the axis end part 72, the connecting terminal ID No. 2 is for the connecting terminal 25 at the second near position to the topside of the axis end part 72, the connecting terminal ID No. 3 is for the connecting terminal 25 at the third near position to the topside of the axis end part 72, and, the connecting terminal ID No. 4 is for the connecting terminal 25 at the fourth near position to the topside of the axis end part 72, as shown in FIGS. 14(a) and 14(b). And it is presupposed that those connecting terminal ID Nos. 1 to 4 are stored in the storage means 28 together with the arrangement orders.

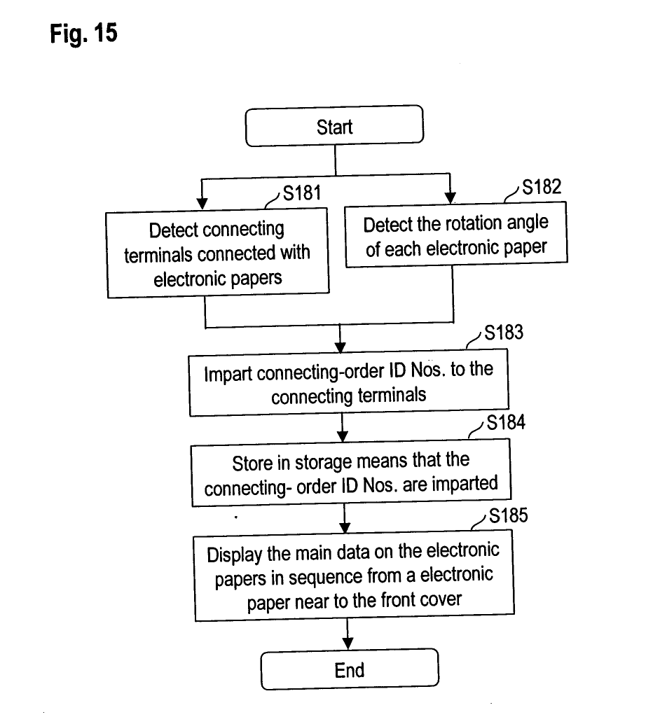

In the first place, after the rotation angle is informed from the position detecting means 64 in the above-mentioned way, the attachment detecting means 60 detects the connecting terminal 25 attached with the electronic paper 10. Regarding the operation of obtaining the rotation angle by the position detecting means 64 and the operation of detecting the connecting terminal 25 attached with the electronic paper, it is not decided in particular to start either operation first. These two operations may be performed in parallel (FIG. 15, S181 and S182).

In the second place, the attachment detecting means 60 obtains the connecting terminal ID number of thus detected connecting terminal 25 from the storage means 28. For example, when the electronic papers 10 are attached to the connecting terminal 25 with the connecting terminal ID No. 1 and the connecting terminal 25 with the connecting terminal ID No. 3, the attachment detecting means 60 obtains the connecting terminal ID Nos. 1 and 3 from the storage means 28.

In addition, the attachment detecting means 60 imparts the connecting-order ID numbers to the connecting terminals 25 with the connecting terminal ID Nos. 1 and 3 obtained above (FIG. 15, S183). But, since the invention assumes that the rotatable axis part 70 is configured to be rotatable, the imparting of the connecting-order ID number is executed according to the rotation angle informed by the position detecting means 64 as described hereinafter.

For example, in the order of the connecting terminal 25 with the connecting terminal ID No. 2, the connecting terminal 25 with the connecting terminal ID No. 1, the connecting terminal 25 with the connecting terminal ID No. 4, and the connecting terminal 25 with the connecting terminal ID No. 3, the rotation angle of each connecting terminal 25 gets small. When the attachment detecting means 60 receives the information of the rotation angles from the position detecting means 64, the connecting-order ID numbers are imparted as follows. That is to say, in this case, the attachment detecting means 60 imparts to the connecting terminal 25 with the connecting terminal ID No. 1 the connecting-order ID No. C1 indicating that the attached electronic paper is the nearest to the front cover 261, as well as to the connecting terminal 25 with the connecting terminal ID No. 3 the connecting-order ID No. C2 indicating that the attached electronic paper is the second near to the front cover 261.

Additionally, the attachment detecting means 60 stores in the storage means 28 that the connecting-order ID Nos. C1 and C2 are imparted (FIG. 15, S184), and notifies the display control means 23 of the connecting-order ID Nos. C1 and C2. Thereby, on receiving the notification, the display control means 23 transfers the main data to the connecting terminals 25 with the connecting terminal ID Nos. 1 and 3. Accordingly, since it does not occur that the main data is sent to the connecting terminal 25 attached with no electronic paper (without the leakage of the display), it is possible to display the main data on the electronic paper in sequence from the electronic paper nearer to the front cover (FIG. 15, S185).

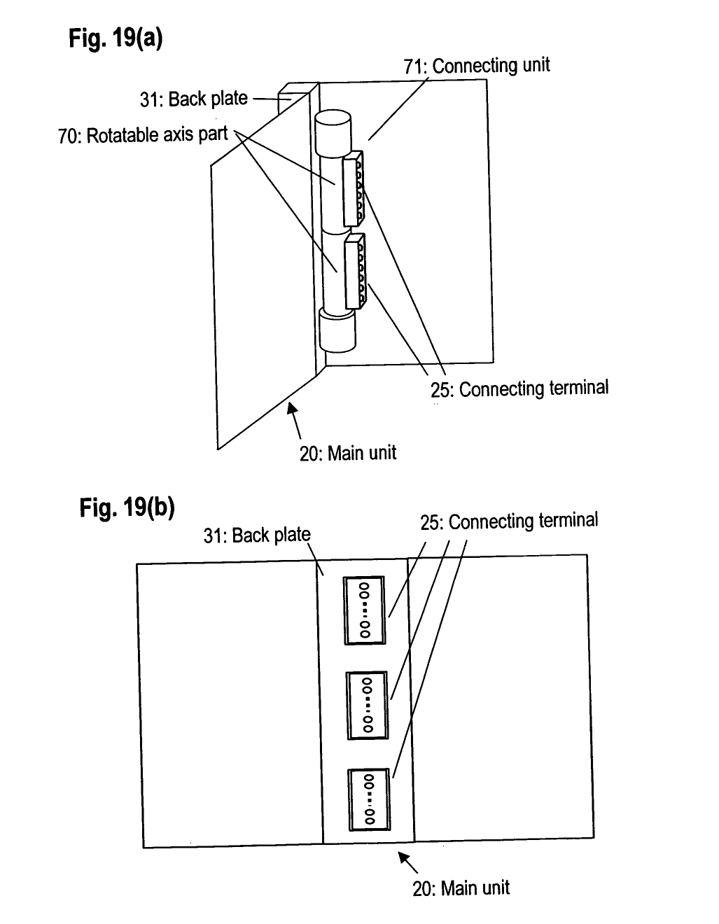

Now, since the connecting terminal 13 of the above electronic paper 10 is fixed to a specific position of the vertical direction of the electronic paper 10, the electronic paper can be connected only with the connecting terminal 25 of the main unit at a position corresponding to the connecting terminal 13. Therefore, as shown in FIGS. 19(a) and 19(b), when a plurality of connecting terminals 25 are provided on respective different positions in the vertical direction of the main unit 20, the electronic paper 10 must have the connecting terminal 13 fixed to a position connectable with each connecting terminal 25 of the main unit 20. This is a big problem. Therefore, to solve the problem, it may adopt the following configuration.

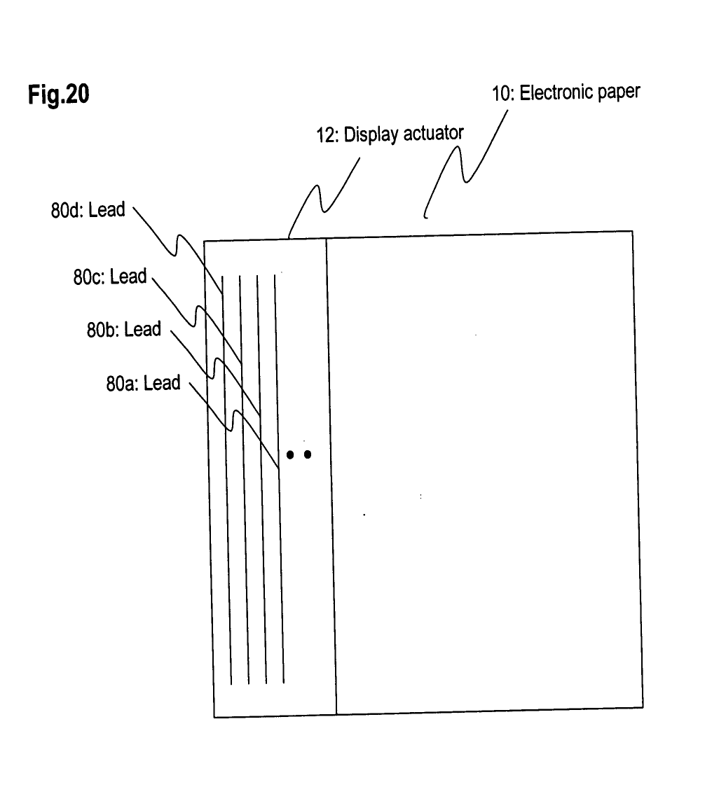

As shown in FIG. 20, the necessary number of leads 80a to 80d is placed in parallel at the end of the electronic paper 10 in the vertical direction of the electronic paper in order to transfer the main data.

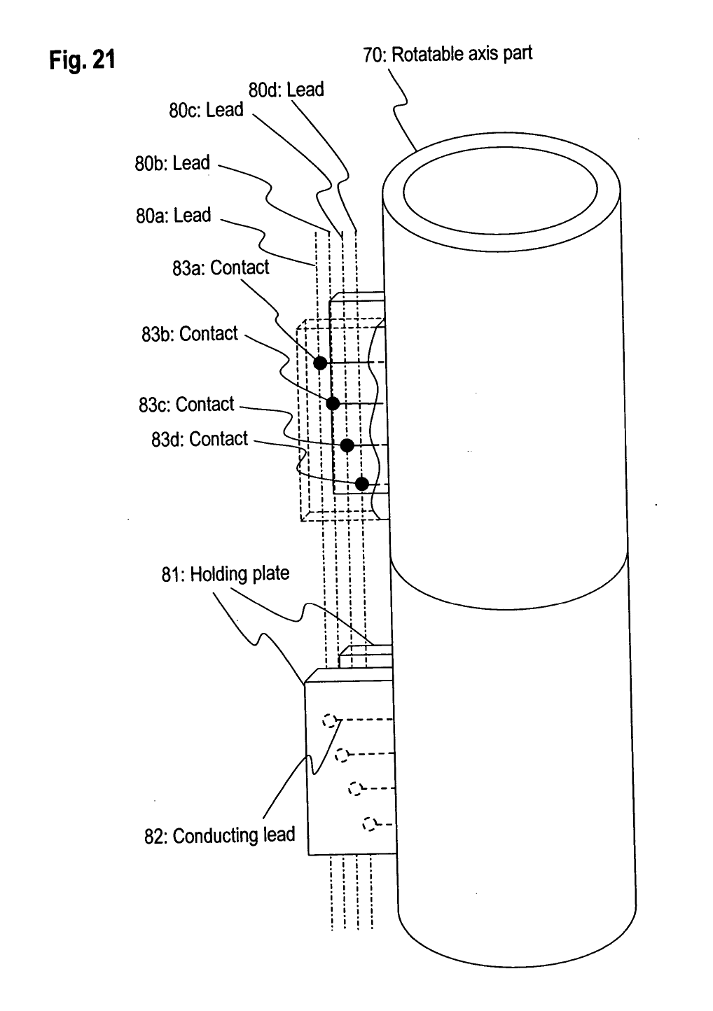

On the other hand, as shown in FIG. 21, the rotatable axis part 70 is provided in the radius direction with two holding plates 81 projecting therefrom so as to holding the electronic paper 10 elastically in the thickness direction. The holding plate 81 is provided with conducting leads 82 of which tops contact with the parallel leads 80a to 80d of the electronic paper 10 respectively, and the conducting lead 82 is conducted to a lead of the main unit.

The number of conducting leads 82 composing each connecting terminal 25 is the same as the number of the parallel leads 80a to 80d of the electronic paper. The conducting leads 82 have contacts 83a to 83d that are points of the conducting leads 82 connectable to the parallel leads 80a to 80d electrically. By holding the connecting terminal 13 of the electronic paper from both sides of the connecting terminal 13 with the holding plates 81 attached to the connecting terminal 25 of the main unit, each parallel lead 80a to 80d is connected to each contact 83a to 83d. Therefore, it is needless to say that the main data transferred by the display control means 23 flows to the specific connecting terminal 13.

When the display control means 23 performs the displaying according to the connecting-order ID number thus informed by the attachment detecting means 60, the connecting-order ID number of the connecting terminal 25 attached with the electronic paper 10 may be indicated on the electronic paper 10. If the connecting-order ID number is indicated on the electronic paper 10, the user can recognize the connecting-order ID number even after the electronic paper 10 is detached from the main unit 20, so that it can makes it easy for the user to confirm the order of the main data displayed on the electronic paper 10.

Now, when the electronic paper detached from a specific connecting terminal 25 is attached to a different connecting terminal 25, the main data are not displayed in the descending order of pages once in a while. To settle such inconvenience, the attachment detecting means 60 may be designed so as to monitor the attachment of the electronic paper all the time, as well as the main data is stored in the storage means 28 in the main unit 20.

In other words, when the attachment detecting means 60 detects that the electronic paper 10 is attached to the connecting terminal 25 or that the electronic paper is detached from the connecting terminal 25, said means 60 informs the display control means 23 of the connecting-order ID numbers imparted to the connecting terminals 25 attached with the electronic paper 10. Thereby, the display control means 23 reads the main data from the storage means 28, and displays the data according to the informed connecting-order ID number.

Besides, it is described in this embodiment that the main data is stored in the storage means 28 of the main unit 20. However, the same effect can be obtained in case the main data is stored in the storage means 28 of the electronic paper 10. That is to say, when the storage means storing the main data is provided to the electronic paper 10, the display control means 23 can obtain the main data from the storage means of the electronic paper 10.

When the main unit 20 is provided with the position detecting means 64, the position detecting means 64 imparts the connecting-order ID number to the connecting terminal 25 and notifies the display control means 23 of the imparted connecting-order ID number while working with the attachment detecting means 60.

Moreover, the invention may be designed so that the main unit 20 is provided with a specific button not shown in the drawing, and when the user pushes the button, the attachment detecting means 60 and the position detecting means 64 are activated. Otherwise, when the electronic paper is turned on power or the display unit of the electronic paper is cleared temporarily, the attachment detecting means 60 and the position detecting means 64 may be activated.

As described above, the invention in this embodiment makes it possible to carry the electronic paper removed from the main unit 20 in hand. When the same means described in the first embodiment are provided to both the main unit 20 and the electronic paper 10, the same effect as in the first embodiment can be obtained.

### EMBODIMENT 3

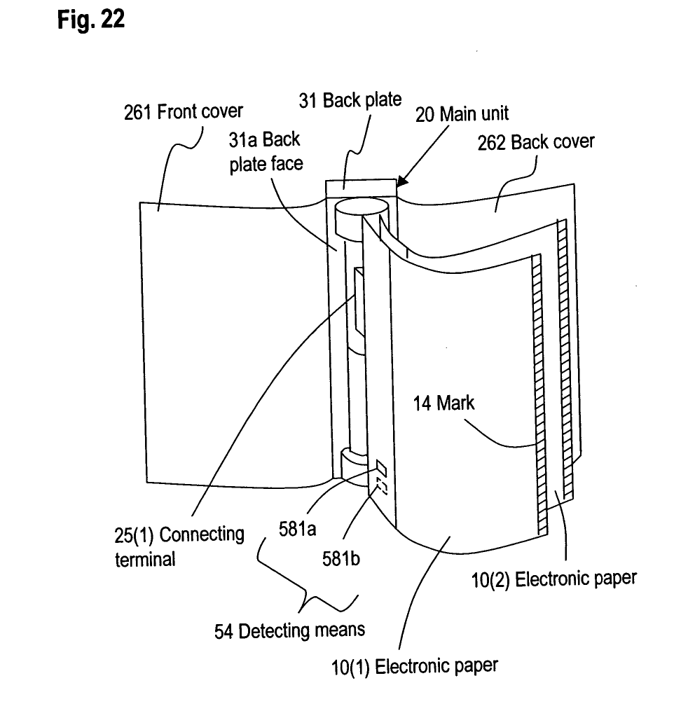

The invention of this embodiment is described here according to FIGS. 22 to 25.

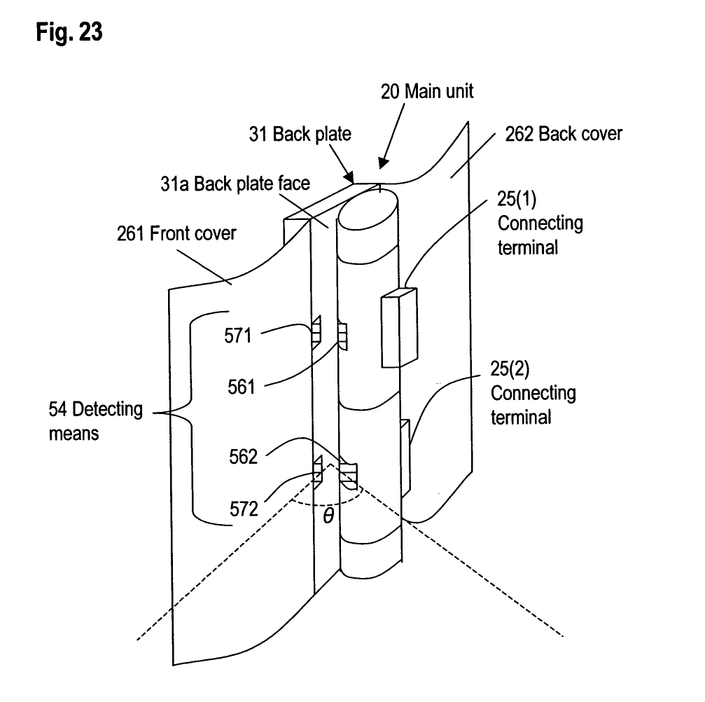

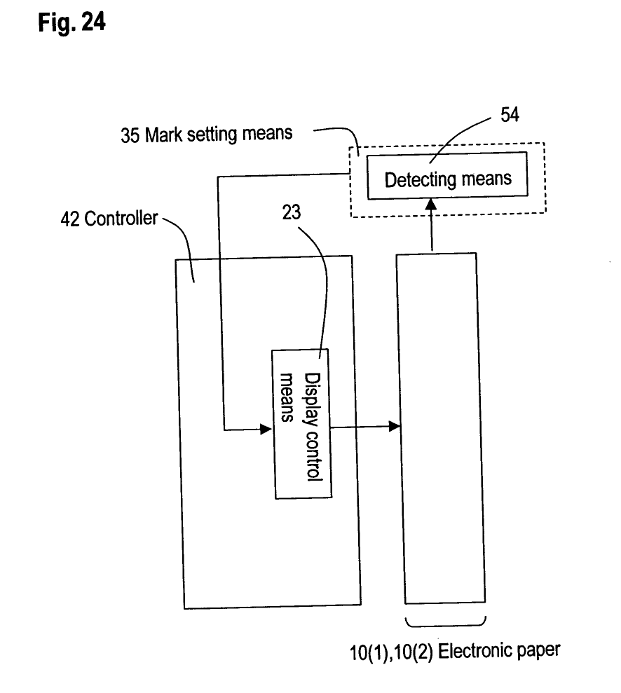

FIG. 22 and FIG. 23 shows a configuration of the electronic paper to which the present invention is applied, and FIG. 24 shows a block diagram of a control system thereof. Besides, the configurations of the main unit of the electronic paper file and the electronic paper 10(e) are the same as in the second embodiment.

In this embodiment, the connecting terminals 25(1) and 25(2) rotatably provided to the main unit 20 are attached to two electronic papers 10(1) and 10(2) respectively. The mark data has been set to the storage means of the mark setting means 35.

First, the mark setting means 35 in this embodiment is provided with a detecting means 54 (a sensor, for example) detecting whether each electronic paper 10(1) or 10(2) is open or not.

The detecting means 54 is provided, on one and the other sides of the display actuator 12 of each electronic paper 10(1) and 10(2) as shown in FIG. 22, with sensors detecting whether the electronic paper 10(1) adjoins the electronic paper 10(2). The sensor provided to one side of the display actuator of the electronic paper 10(i) is shown as a sensor 581a and the sensor provided to the other side is shown as a sensor 581b.

When both the sensors 581a and 581b are ON, the electronic paper 10(1) are held between the front cover 261 and the electronic paper 10(2). When only the sensor 581b is ON, the electronic paper is open. When only the sensor 581a is ON, one side of the electronic paper 10(1) is shut toward the front cover 261.

By comprising the sensors 581a and 581b in such way, the detecting means 54 can detect a status that the electronic paper 10(1) is open. It is needless to say that the display actuator of the electronic paper 10(2) may be provided with the same sensors like the electronic paper 10(1), too.

The detecting means 54 can detects the angle θ between a specific position of the main unit 20 and the electronic papers 10(1) or 10(2) attached rotatably to the connecting terminal s 25(1) and 25(2). The specific position of the main unit 20 is on the back plate face 31a wherein the back plate 31 is provided with the connecting terminals 25(1) and 25(2).

In order to detect the angle θ, the detecting means 54 comprises light sources 561 and 562 provided to the connecting terminals 25(1) and 25(2), and light receiving units 571 and 572 provided to the back plate 31 for receiving the light from the light sources 561 and 562, as shown in FIG. 23.

That is to say, the light source 561 is placed so as to oppose to the back plate 31a when the electronic paper 10(1) attached to the connecting terminal 25(1) is perpendicular to the back plate 31a. The right receiving unit 571 is placed so as to detect the light from the light source 561 of the connecting terminal 25(1) when the electronic paper 10(1) attached to the connecting terminal 25(1) is open over 90 degree toward the back plate 31a.

The light source 561 and the right receiving unit 571 are designed in such way, so that the detecting means 54 can detect the status that the open angle θ of the electronic paper 10(1) is over 90 degree. As a matter of course, the light source 562 and the light receiving unit 572 are placed in the same way as the light source 561 and the light receiving unit 571.

Besides, since the detected data correspond to the connecting terminals 25(1) and 25(2) respectively, the said data also correspond to the connecting terminal ID numbers of the connecting terminal 25(1) and 25(2). In the following description, the connecting terminal ID number is the electronic paper number showing the electronic papers 10(1) and 10(2) attached to the connecting terminal 25(1) and 25(2) respectively.

The detecting means 54 may be provided on the front cover 261 of the main unit 20 with a detection-indicating unit for indicating the status that the electronic papers 10(1) or 10(2) is open and that the angle θ is over a specific value. As the displaying configuration of the detection-indicating unit, it is possible to adopt the method of lighting a light emitting diode, for example. According such configuration, the user can recognize visually whether the electronic paper 10(1) is open or not, or whether the angle θ is over a specific value.

And according to the instruction of the detecting means 54, the mark setting means 35 gives the display control means 23 the electronic paper number of the electronic paper that is open and of which angle θ is over the specific value, together with the instruction to indicate the mark corresponding to the electronic paper. Together with the electronic paper number and the instruction to indicate the mark, the mark data set in the storage means of the mark setting means 35 is also gives to the display control means 23 by the mark setting means 35.

For instance, when only the sensor 581a of the electronic paper 10(1) is ON and the light receiving unit 571 detects the light from the light source 561 of the connecting terminal 25(1), the status that the electronic paper 10(1) is open is expressed by the information “the electronic paper No. 101”. In this case, the display control means 23 correlates the received mark data and “the electronic paper No. 101” and stores them in the storage means of the display control means 23. The stored information has been retained therein until the detecting means resends the new ID number of the open electronic paper.

The display control means 23 refers to the information stored in the storage means according to the stored “the electronic paper No. 101”, and indicates on the electronic paper 10(1) the mark based on the mark data corresponding to the electronic paper No. 101. Thereby, the mark can be indicated on the open electronic paper.

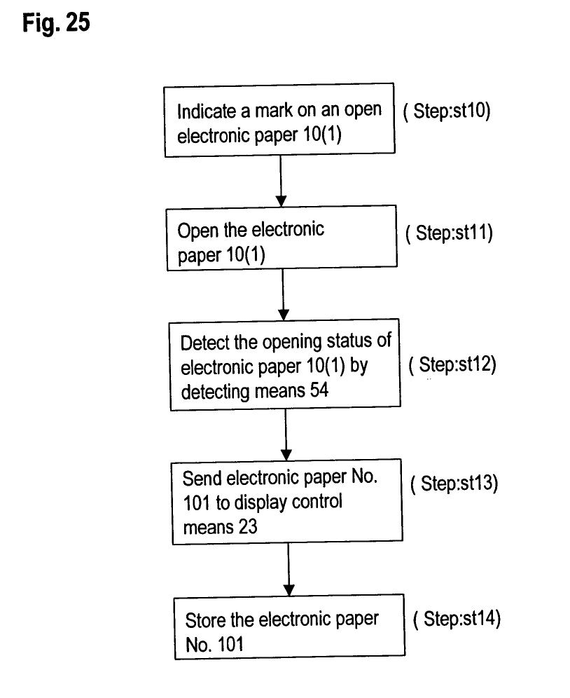

Next, the mark setting operation executed by the mark setting means 35 is described hereafter according to the flowchart shown in FIG. 25. In the description, providing that two electronic papers 10(1) and 10(2) are attached to the main unit, the electronic paper 10(1) displays page 201 of the main data, and the electronic paper 10(2) displays page 202 of the main data, and the invention under such status is explained.

First, when the user wants to indicate the mark on the electronic paper 10(1) (FIG. 25, Step: st10 to st11), he opens the electronic paper 10(1) (FIG. 25, Step: st11 to st12). Thereby the detecting means 54 detects the status that the electronic paper 10(1) is open (FIG. 25, Step: st12 to st13), then the mark setting means 35 gives the electronic paper No. 101 to the display control means 23 (FIG. 25, Step: st13). As a matter of course, together with the electronic paper No. 101, the mark setting means gives the display control means 23 the specific mark data and the instruction to indicate the mark on the electronic paper 10(1) corresponding to the electronic paper No. 101.

The display control means 23 correlates the electronic paper No. 101 with the mark data thus received and stored them in the storage means of the display control means 23 (FIG. 25, Step: st14). And when it is determined, referring to the information stored in the storage means, that the electronic paper No. 101 corresponds to the electronic paper 10, the display control means 23 controls the indication of the mark 14 on the electronic paper 10(1) based on the mark data corresponding to the electronic paper No. 101.

It is needless to say that, even when the user operates the display console 51 and changes the content displayed on the open electronic paper 10(1) to the content of page 203, the control of the indication of the mark on the electronic paper 10(1) is executed by the display control means 23.

Next, when the user opens the electronic paper 10(2), the specific mark data and the electronic paper No. 102 is given to the display control means 23 in the same way as above. Thereby, the display control means 23 deletes the electronic paper No. 101 stored as above, and correlates and stores the received mark data and electronic paper No. 102. Then the display control means 23 controls the indication of the mark on the electronic paper 10(2) based on the mark data corresponding to the electronic paper No. 102.

Besides, It is described in the above that the mark is indicated automatically on the opening electronic paper, however, it may be designed so as to cancel the indication of the mark 14. In such case, an indication-cancel key or the like is provided to a specific position of each electronic paper 10(1) and 10(2). And, at the time of pushing the indication-cancel key of the opening electronic paper 10(1), the display control means 23 can delete the registration of the electronic paper No. 101.

Moreover, the above description exemplifies a configuration that the connecting terminals 25(1) and 25(2) of the main unit are rotatable, but even when the connecting terminals 25(1) and 25(2) are configured to fix to the main unit 20 as shown in FIG. 1, it is sure to obtain the same effect because the above-mentioned detecting processing can be executed.

As mentioned above, the operation to indicate the mark on the open electronic paper and cancel the indication of the mark can be carried out in simple manner according to the invention of this embodiment.

### EMBODIMENT 4

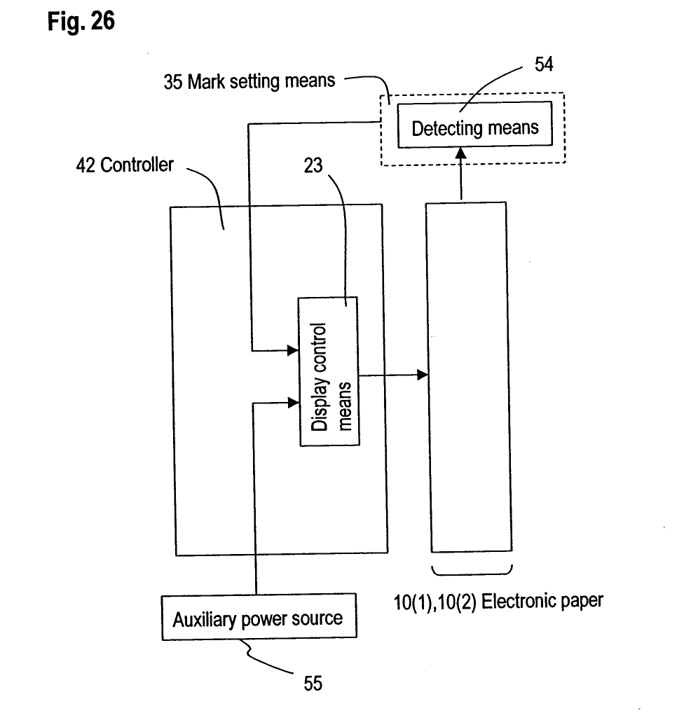

FIG. 26 shows a block diagram showing a control system of the electronic paper file of this embodiment. The electronic paper file of the embodiment is configured same as in either one of the above first to third embodiments. In addition to such configuration, the electronic paper file comprises an auxiliary power source 55 for supplying power to the display control means 23 and the light emitting control means 24 when the power of the main unit 20 is turned off. The auxiliary power source 55 is an electric power (a battery, for example) provided inside or outside of the main unit 20 of the electronic paper file.

After the power of the main unit 20 is turned off manually or by the auto-power-off function, and the like, or when the power is turned on again after the Off-status, the operation for indicating the mark on a specific electronic paper is explained hereafter. As a matter of course, the electronic paper No. 101 and the mark data stored in the display control means 23 are retained therein even after the power of the main unit is turned off, and the mark setting means 35 is provided with the detecting means 54.

First, it is assumed that the user opens the electronic paper 10(1), and then refers to page 201 of a specific document, a book, or the encyclopedia, for example; said page is displayed on the electronic paper 10(1). And the display control means 23 stores the electronic paper No. 101 indicating the open status being correlated with the specific mark data, in the same way as in the third embodiment.

The display control means 23, which is activated by the auxiliary power source 55 after the power of the main unit is turned off, displays the mark 14 based on the main data on the electronic paper 10(1) corresponding to the stored electronic paper No. 101. At this time, the range of the mark 14 displaying on the electronic paper 10(1) is made to emit light by the light emitting control means 24 activated by the auxiliary power source 55.

In this embodiment, the invention is designed that the mark 14 is indicated on the electronic paper 10(1) even when the power of the main unit 20 is turned off. But the mark 14 may be indicated when the power is turned off again. The time to indicate the mark can be determined by a key provided to the main unit 20.

As described above, the invention described in this embodiment is designed that the specific mark can be indicated on the electronic paper when the power of the main unit is turned off or when the power of the main unit is turned on again. Accordingly, even when the user shuts the book that he is reading now, a mark is displayed on the shut page immediately after the power of the main unit is turned off or turned on again. Therefore, the user can open the previous position where he has been read.

### EMBODIMENT 5

This embodiment is explained here regarding different points from the above first to fourth embodiments.

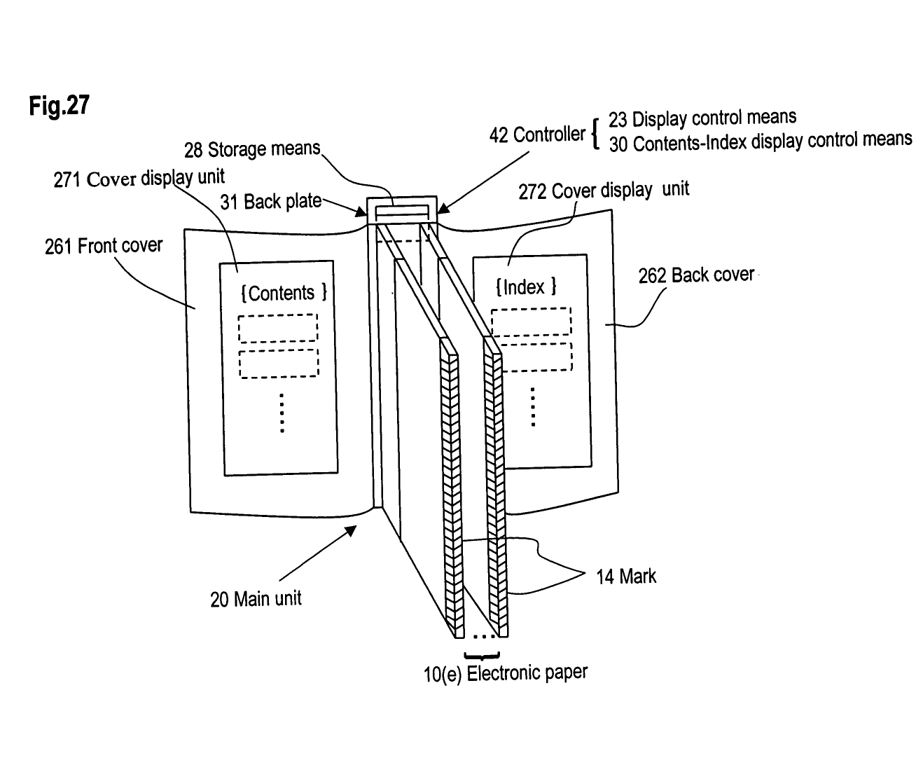

As shown in FIG. 27, it is configured in this embodiment that a Contents-Index display control means 30 be provided in the controller 42, said means 30 for displaying the table of contents (Contents) and the Index, and additionally a cover display unit 271 for displaying the Contents and the Index is provided at a specific position of the front cover or the back plate cover 32.

The cover means either the front cover 261 or the back cover 262. In the following description, the front display unit of the front cover 261 is called a “cover display unit 271”, and the front display unit of the back cover 262 is called a “cover display unit 272”.

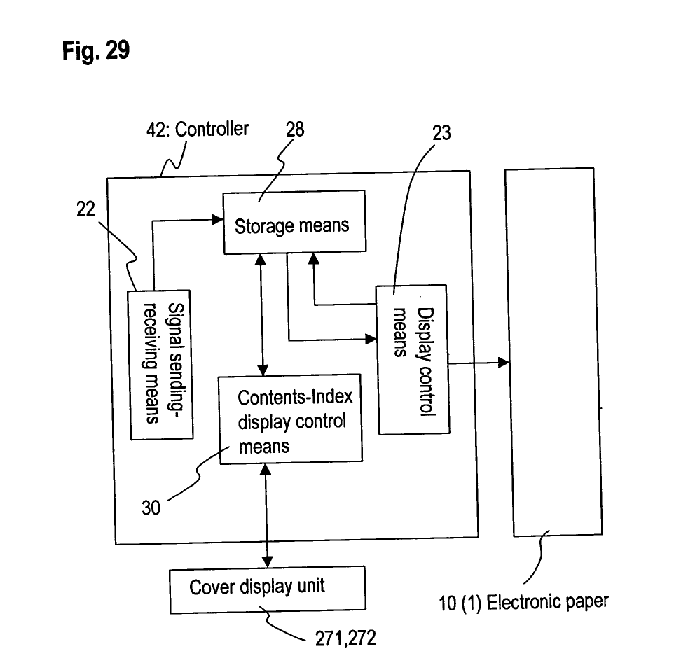

Next, the operation of this electronic paper file is explained according to FIG. 29.

First, the signal sending-receiving means 22 receives the data to display on the display unit 11 of the electronic paper 10(e) from the other electronic paper or the personal computer, and stores said data in the storage means 28 as a main data. It is considered that thus stored main data is a data of electronic book, and comprises a data relevant to a text of the electronic book (which is call a “text data”), a data relevant to the Contents (which is called “Contents data”), and data relevant to the Index (which is called “Index data”).

A specific mark data is set to the text data by the following method. For example, when the Contents consists of Chapters, a different mark data per chapter is set to the text data in order to group the text by chapter. As a matter of course, in order to group the text by Index, a different mark data per Index may be set to the text data.

The Contents-Index display control means 30 displays the Index on the cover display unit 272 provided on the back cover 262 as well as the Contents on the cover display unit 271 provided on the front cover 261, as shown in FIG. 27. The displaying by the Contents-Index display control means 30 is performed according to the Contents data and Index data included in the main data stored in the storage means 28.

FIG. 27 exemplifies a configuration that, as well as the Contents is displayed on the cover display unit 271 on the front cover 261, the Index is displayed on the cover display unit 272 on the back cover 262. However, the invention is not limited to this. That is to say, the invention can adopt either one configuration that the cover display unit 271 displays the Contents, and that the cover display unit 272 displays the Index.

The Contents data comprises title data corresponding to a specific unit (section, or chapter, for example) (characters, and the like), range data of this unit (page No. or paragraph No.), and name data representing the whole main data. The Index data comprises specific descriptive data (a word such as environment, or education), and the location number corresponding to such descriptive data (the page No. and the paragraph No.) The title indicated by the title data included in the Contents data, the page number indicated by the range data included in the Contents data, those are displayed on a specific position of the cover display unit 271. Each word indicated by the descriptive data included in the Index data, and the page number indicated by the location number are displayed on a specific potion of the cover display unit 272.

In case of the main data without the Contents data and the Index data, (that is, the main data with the text data only), the Content-Index display control means 30 may search the content of the main data and create the Contents data and the Index data. In addition, the Contents-Index display control means 30 may display the number of electronic papers attached to the main unit 20 on the cover display unit 271 or cover display unit 272 other than the title and the page number. According to such configuration, even when the main unit 20 is attached with a plurality of electronic papers, the user can know the number of electronic papers with ease.

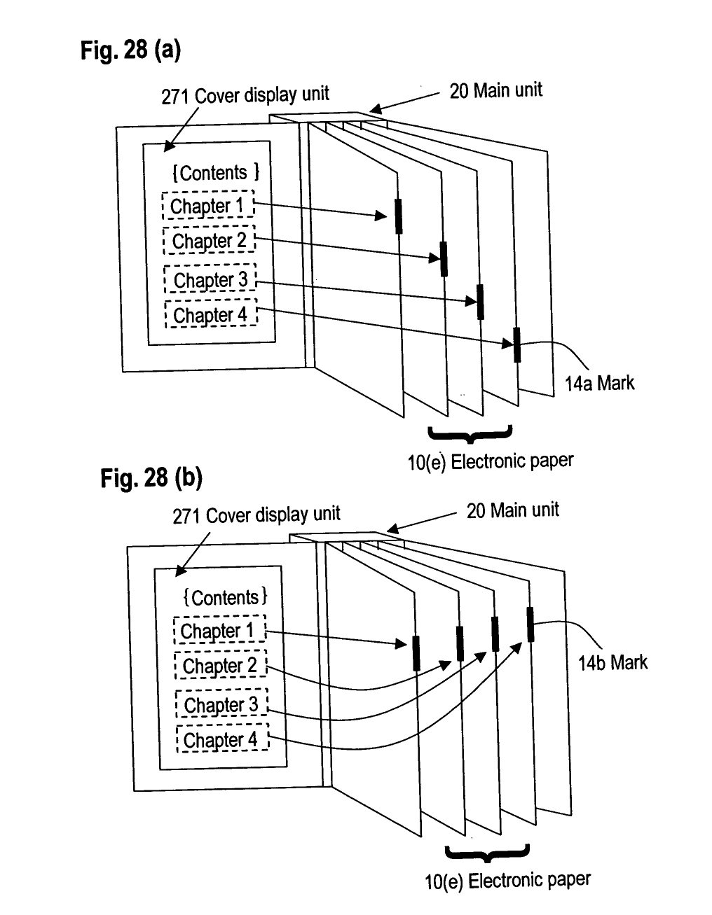

According to FIGS. 28(a) and 28(b), here is explained the operation that the display control means 23 indicates the marks corresponding to the Contents items (Chapter 1 to Chapter 4) displayed on the cover display unit 271.

As shown in FIG. 28(a), same size of marks 14a are indicated on respective positions overlapping each display position of Chapter 1 to Chapter 4 of the Contents. Accordingly, since the electronic papers are grouped by chapter, the user can find easily the electronic paper displaying the page corresponding to each chapter.

And as shown in FIG. 28(b), the marks 14b indicated at the same position are indicated in different color per chapter of the Contents. According to this configuration, it is also possible to group the electronic papers by chapter, so that the user can find the electronic paper displaying the page corresponding to each chapter.

In the above description, the front display unit displaying the Contents and the Index is provided to a specific position of either the front cover or the back plate cover 32. However, the invention is not limited to this. That is to say, the Contents and the Index may be displayed on the display unit 11 of the electronic paper.

The control performed by the Contents-Index display control means 30 may be made by display control means 23. In this case, the display control means 23 controls the displaying of the main data on each electronic paper 10(e), and controls the displaying of the Contents and the Index on the cover display unit 271 and cover display unit 272.

### EMBODIMENT 6

This embodiment is explained here regarding the different points from the above first to fifth embodiments.

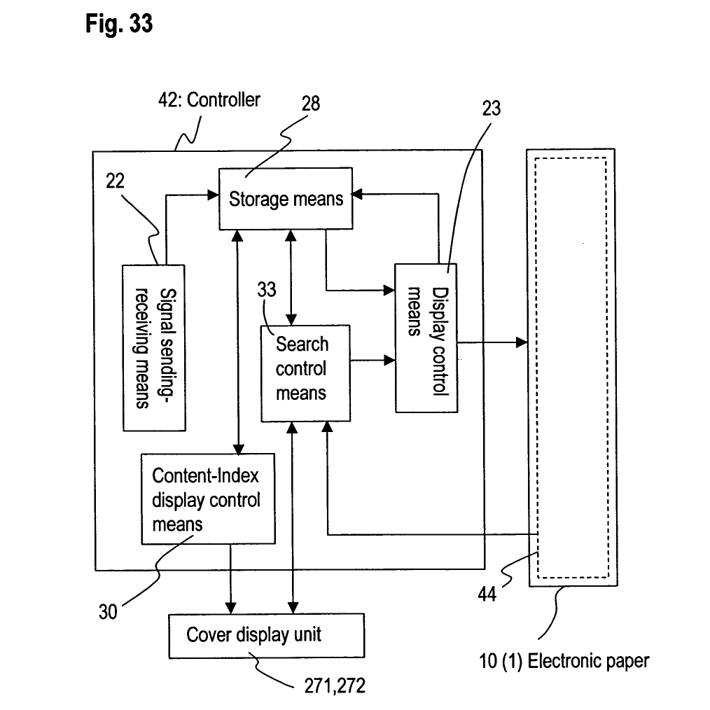

In the embodiment, as shown in FIG. 33, a selecting means 44 for selecting a search target is provided to the display unit 11 of the electronic paper 10 or the cover display unit 271 and cover display unit 272, and the controller 42 is provided therein with a search control means 33 for searching the main data in the storage means of the main unit 20 based on the data selected by the selecting means 44.

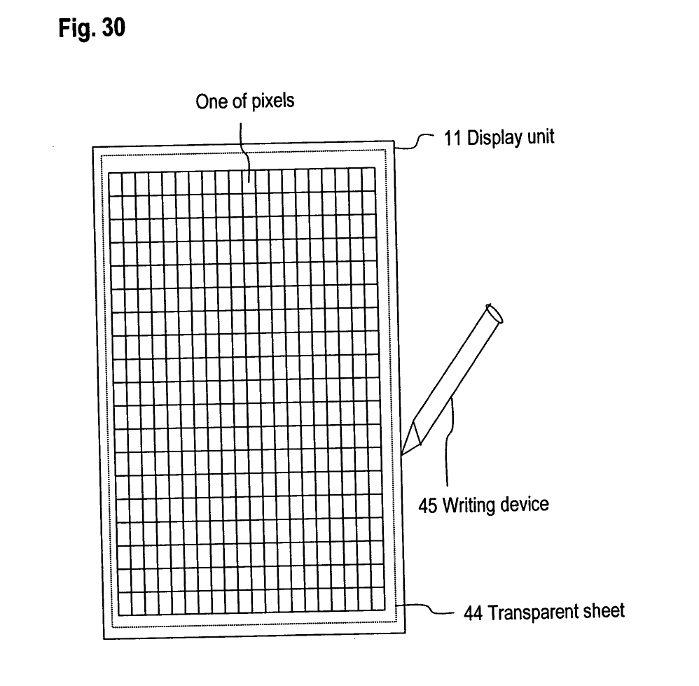

A configuration shown in FIG. 30 can be consider to realize the selecting means 44, which adopts a transparent sheet 44 provided with the digitizer function that can detect a contact position of a writing device 45 (a sharp-pointed device like a pen). Here, it presupposes that the transparent sheet 44 is provided to the upper face of the display unit 11 of the electronic paper 10(1).

First, the writing device contacts to the display position of characters to be search from the characters displayed on the display unit 11 over the transparent sheet 44. Thereby, the transparent sheet 44 detects the position of the character to be searched by means of the digitizer function, and then gives the detected position information (address) to the search control means 33. That is to say, the character to be searched can be selected by mean of the transparent sheet 44.

If it the user can select a position where the characters are displayed, it is not required to detect the position by means of the digitizer function as described above. For instance, the position where the characters are displayed can be selected with the pointing device like the mouse, so that the same effect can be obtained.

The search control means 33 searches the main data in the storage means 28 for the character data corresponding to the received position information. And, since the mark data is set to the main data as described in the first embodiment, the mark data set to the character data searched in such way (the main data) is given to the display control means 23. Thereby, the display control means 23 controls the indication of the mark on the electronic paper 10(1) based on the received mark data.

The above describes the method that the data to be a target of search is selected on the display unit 11 of the electronic paper 10(1). The method that the search target data is selected from the main unit is described here. And, the selecting means 44 (the digitizer function) is to be provided to the cover display unit 271 and cover display unit 272 of the main unit.

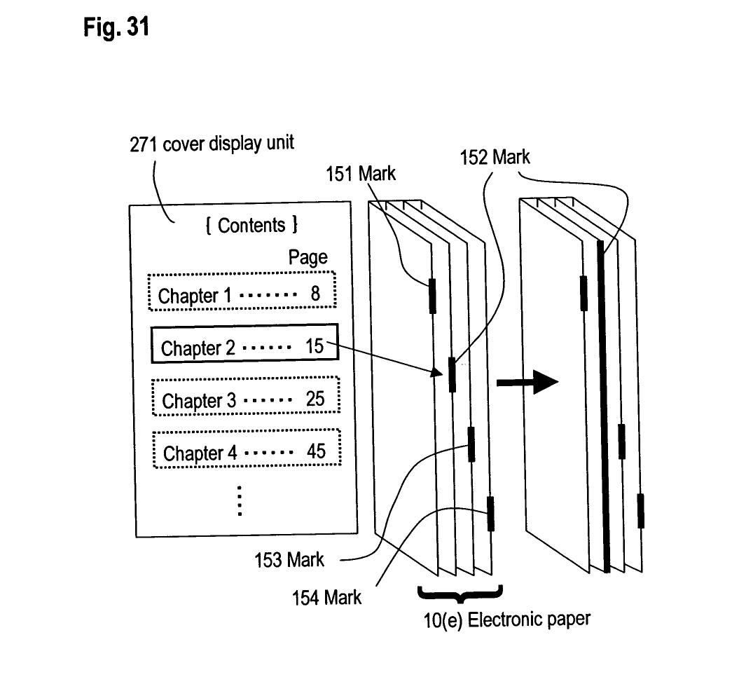

As shown in FIG. 31, the Contents-Index display control means 30 obtains the Contents data from the storage means 28 in the way as mentioned in the fifth embodiment, and displays on the cover display unit 271 of the main unit 20 each item comprising the title of each chapter and page numbers of the Chapters based on the Contents data. And, the display control means 23 shown in FIG. 31 indicates the marks on each electronic paper 10(e) attached to the main unit 20.

In FIG. 31, an item, “Chapter 1 . . . page 8”, corresponds to the mark 151; an item, “Chapter 2 . . . page 15”, corresponds to the mark 152; an item, “Chapter 3 . . . page 25”, corresponds to the mark 153; an item, “Chapter 4 . . . page 45”, corresponds to the mark 154.

FIG. 31 also exemplifies a case that one chapter is composed from one electronic paper. But, the number of electronic papers composing one chapter may be plural. In this case, the mark (mark 151, for example) may be indicated on all of the plural electronic papers composing one chapter (Chapter 1, for example), or only one of plural electronic papers composing one chapter (Chapter 1) that is displaying the first page thereon may indicate the mark.

When the item “Chapter 2” displayed on the cover display unit 271 is selected by the above-described method, the search control means 33 searches the Contents data stored in the storage means 28 for a character string “Chapter 2”. When find out the Contents data including the character string “Chapter 2”, the search control means 33 searches the text data for a page corresponding to the page number included in the Contents data (the page corresponding to Chapter 2). Additionally, the search control means 33 gives the display control means 23 the mark data set to the main data including the character string “Chapter 2” together with the search result (the page corresponding to Chapter 2). Thereby, the display control means 23 changes the indication of the mark 142, such as enlarges the indication range of the mark, based on the search result and the mark data thus received.

Next, here is explained an operation for searching for a page or a word corresponding to each item of the Index by means of the Index displayed on the cover display unit 272 of the main unit 20

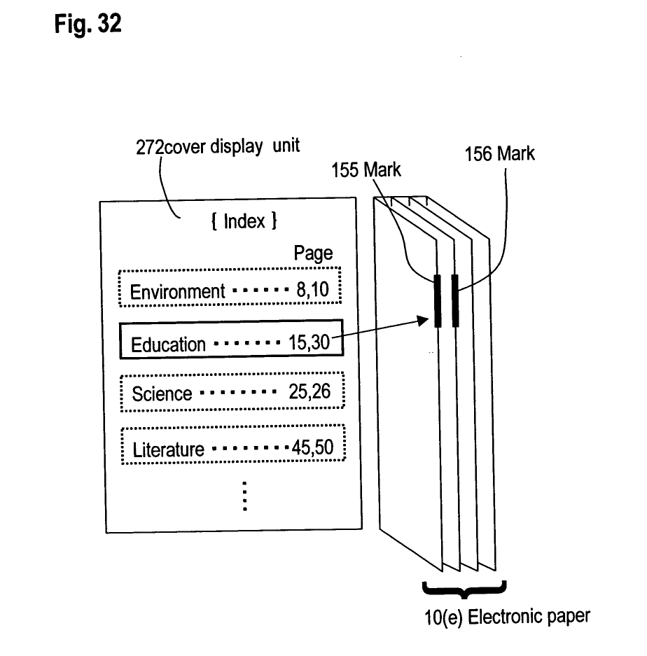

As shown in FIG. 32, the Contents-Index display control means 30 obtains the Index data from the storage means 28 in the way as described in the fifth embodiment. And according to the Index data, each word and the page numbers of respective words are displayed on the cover display unit 272. When the “education” item displayed on the cover display unit 272 is selected, the search control mans 33 performs the search like the same procedure as above, and then gives the display control means 23 the mark data corresponding to the Index data together with the search result.

The display control means 23 indicates the marks on each electronic paper 10(e) attached to the main unit 20 according to the received mark data. In this case, two electronic papers displaying pages 15 and 30 respectively display the mark 155 and 156 corresponding to the “education . . . Pages 15 and 30” item.

As described above, in this embodiment, it is possible to search for a desired word and display the mark on the page based on the search result. Accordingly, it is needless to say that the user can easily find out the page on which a desired word and the like are displayed.

### EMBODIMENT 7

In prior arts, when a plurality of electronic papers are overlaid one on another, nothing could be indicated on a face composed from the side edges of these electronic papers (a face opposite to the back plate 31 of the main unit 20, which is called a “side face 38”). This embodiment exemplifies an operation for controlling the indication of the mark on the side face 38 (the side-face indication), and only different points from the first to sixth embodiments are explained First, the user sets the mark data from the personal computer provided with the mark setting system. In the hard disk of the personal computer, the data of the electronic book is stored per page unit. Besides, the personal computer is not shown in the drawing because it is a multipurpose type except the equipment of the mark setting system.

When the mark setting system is activated, a monitor of the personal computer displays a main menu of this system. After the user selects an item to set the mark (which is called “mark impartation setup item”) from the items included in the main menu by means of an input means such as the keyboard, and the mouse, the monitor of the personal computer displays a side-face setup item together with a page specifying item that will be explained later.

The side-face setup item is for setting easily the mark data corresponding to the mark 14 displayed on the side face 38. When the side-face setup item is selected by means of the input means such as the keyboard or the mouse, the following side-face setting menu 34 is displayed.

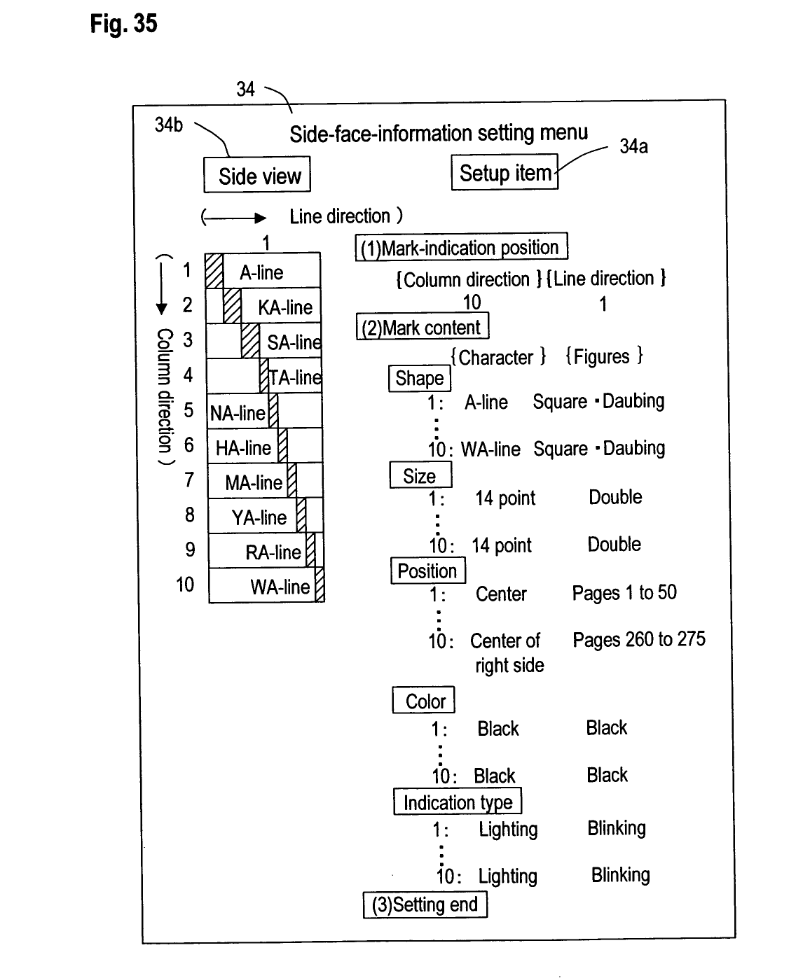

Specifically, the side-face setting menu 34 comprises two menus as shown in FIG. 35, a setup item 34a and a side view 34b corresponding to the setup item 34a.

The side view 34b expresses a side face 38 of the electronic paper.

A “mark-indication position” included in the setup item 34a has a “line direction” item and a “column direction” item. The “column direction” corresponds to the vertical direction of the side view 34b, and the “line direction” corresponds to the horizontal direction of the side view 34b.

Into the “column direction”, the user inputs the number of divisions when the side face 38 is divided in the column direction. Thereby, the mark-indication position in the column direction can be set. For example, when “10” as the division number is inputted, the side face 38 is divided into “10” in the column direction. Nos. 1, 2, . . . 10 indicating the indication positions in the column direction are imparted to the divided regions in sequence from the top. When the division number is not inputted, the same setting processing is performed based on a specific initial value.

Into the “line direction”, the user inputs the division number when the side face 38 is divided in the line direction. Thereby, the mark-indication position in the line direction can be set. For example, when “1” as the division number is inputted, the side face 38 is divided into 1 in the line direction. The number (No.1, in this case) indicating the indication position in the line direction is imparted to the divided regions in sequence from the left side. When the division number is not inputted, the same setting processing is performed based on a specific initial value.

By both items of the “line direction” and the “column direction” in the “mark-indication position” menu, the region on the side face 38 to indicate the mark can be set as described above.

The “mark content” menu is for setting either one of a “character”, a “figure”, and both of them as the mark type, and also to specify a “shape”, a “size”, a “position”, a “color”, and an “indication type” of the mark. The content to be set in each item should correspond to those specified in the “line direction” and the “column direction” (in this case, the indication position Nos. 1, 2, . . . , 10).

To the “shape” item, a character or a character code is inputted, along with a pattern or shape of the figure. That is to say, as the “character”, “A-line” is inputted to No.1 indicating the indication position. Likewise, “KA-line” is inputted to No.2, . . . , and “WA-line” is inputted to No.10. As the “figure”, “square, daubing” is inputted to No.1. Likewise, “square, daubing” is inputted to No.2, . . . , and “square, daubing” is inputted to No.10. Beside, if the character and figure are not inputted, the same processing is performed based on a specific initial value.

To the “size” item, a character size (a point, or the like) is inputted, along with a size of the figure (the magnification to the reference indication width). That is to say, as the “character”, “14 point” is inputted to No.1 indicating the indication position. Likewise, “14 point” is inputted to No.2, . . . , No.10 respectively. As the “figure”, if the figure indication width set in “A-line” to “SA-line” is double that in “TA-line” to “WA-line”, “×2” is inputted to Nos.1 to 3, while “×1” is inputted to Nos. 4 to 10. Beside, if the character and figure sizes are not inputted, the same processing is performed based on a specific initial value.

To the “position” item, the indication position of character (left end, for example) is inputted along with the indication width of the figure (Page No., for example). That is to say, as the “character”, “center” is inputted to No. 1 indicating the indication position. Likewise, the “center of right side” is inputted to No.2, . . . , the “center of right side” is inputted to No. 10. Additionally, as the “figure”, “pages 1 to 50” is inputted No.1. Likewise, “pages 51 to 95” is inputted to No. 2, . . . , “pages 260 to 275” is inputted to No. 10. Besides, if the character indication position and the figure indication width are not inputted, the same processing is performed based on a specific initial value.

To the “color” item, the character color and the figure color are inputted. That is to say, as the “character”, “black” is inputted to No. 1 indicating the indication position. Likewise, “black” is inputted to Nos.2 to 10. In addition, as the “figure”, “black” is inputted to No. 1. Likewise, “black” is inputted to Nos. 2 to 10. Besides, if the character and figure colors are not inputted, the same processing is performed based on a specific initial value.

The “indication type” item is for selecting to make the indication of the character or figure light or blink. That is to say, as the “character”, “lighting” is inputted to No. 1 indicating the indication position. Likewise, “lighting” is inputted to Nos. 2 to 10. Additionally, as the “figure”, “blinking” is inputted No.1. Likewise, “blinking” is inputted to Nos. 2 to 10. Besides, if the selection of blinking or lighting is not inputted, the same processing is performed based on a specific initial value.

For the precise setting to each item, it is preferable that the number of electronic papers attached to the electronic paper file and the height 143 of a mark piece 14a are determined in advance (by overlaying a plurality of electronic papers one after another, one mark is formed. Therefore, the mark indication made by one electronic paper is called the “mark piece 14a”). This is because the number of electronic papers corresponds to the number of pixels in the line direction, while the height 143 of the mark piece 14a corresponds to the number of pixels in the column direction. Particularly, in case of the full color displaying, since the number of electronic papers in the line direction is three times as much as that in case of the mono color displaying, the above-mentioned setting per item is required.

In the “side view” 34b displayed on the side-face setup menu 34, the mark is displayed imitationally based on the information selected per setup item, so that the user can recognize visually the mark indicated base on this set content. Besides, each item of the “setup item” 34a may be inputted directly to the “side view” 34b displayed on the side-face setup menu 34.

After the setting of the above respective items, the user selects the “(3) setting end” item displayed in the side-face setup menu 34, the screen turns back to the main menu of this system. And according to the mark data set as above, the mark piece data to be set per page unit or per paragraph unit is created. The mark piece data thus created is set to the data stored in the hard disk provided to the personal computer (set per page unit or per paragraph unit).

On the other hand, the user inputs to the page selection item of the main menu the page number to which the mark piece data is set, by means of the input means like the keyboard or the mouse. After the page number is inputted to the page selection item, the monitor of the personal computer displays the shape setup item (not shown in the drawing) such as “the indication position of the mark piece”, “the color of the mark piece”, and “the indication type of the mark piece (lighting or blinking) ”. After the user selects each shape setup item as above, the mark piece data is created corresponding to the shape setup item thus selected, and set to the page with the inputted page number. It is sure to set the mark data no only per the page unit, but also per specific paragraph or word unit.

The data to which the mark piece data is set is stored as the main data in the storage means 28 through the signal sending-receiving means 22 of the controller 44 shown in FIG. 33. And as well as the display control means 23 gives each electronic paper 10(e) the stored main data, the mark piece 14a based on the mark piece data included in the main data is displayed on the electronic paper 10(e) respectively.

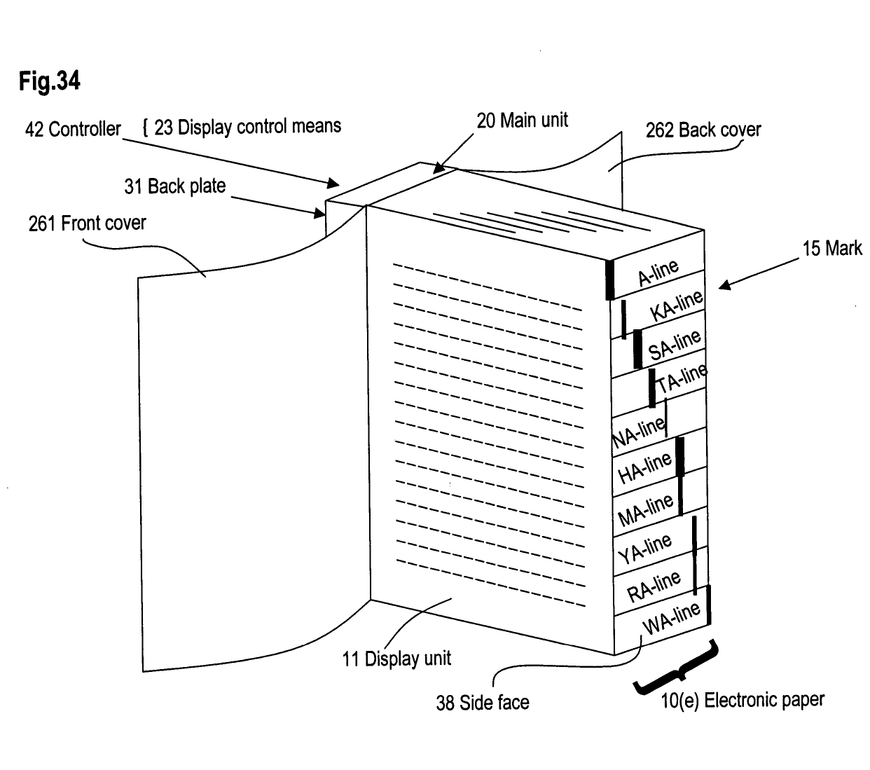

Therefore, on the side face 38 wherein the specific number of electronic papers is overlaid one after another, the mark 14 gathering the mark pieces 14a appears. As a matter of course, in this case, the mark 14 is the same character and figure as the “side view” 34b on the side-face setup menu 34 as shown in FIG. 34.

The other method of setting the mark data is to display the above-mentioned menu on the display unit of the electronic paper attached to the main unit 20 or on the display unit of the front display unit provided on the front cover 261 or back cover 262 of the main unit 20, and then input necessary items to this menu. In such case, the mark data can be set to the main data stored in the storage means 28 of the main unit 20, in addition the data can be also stored in a specific storage means provided to the display control means 23. It is needless to say that a key to turn the side view displaying ON/OFF may be provided to a specific position of a specific electronic paper or the main unit 20 of the electronic paper file.

As described above, the invention of this embodiment can display the mark like the character and the figure on the side face 38 formed when the specific number of electronic papers 10(e) are overlaid one after another, so that the use can easily find out the electronic paper where the main data to be an object is displaying.

### EMBODIMENT 8

The following is the explanation about this embodiment regarding only different points from the seventh embodiment.

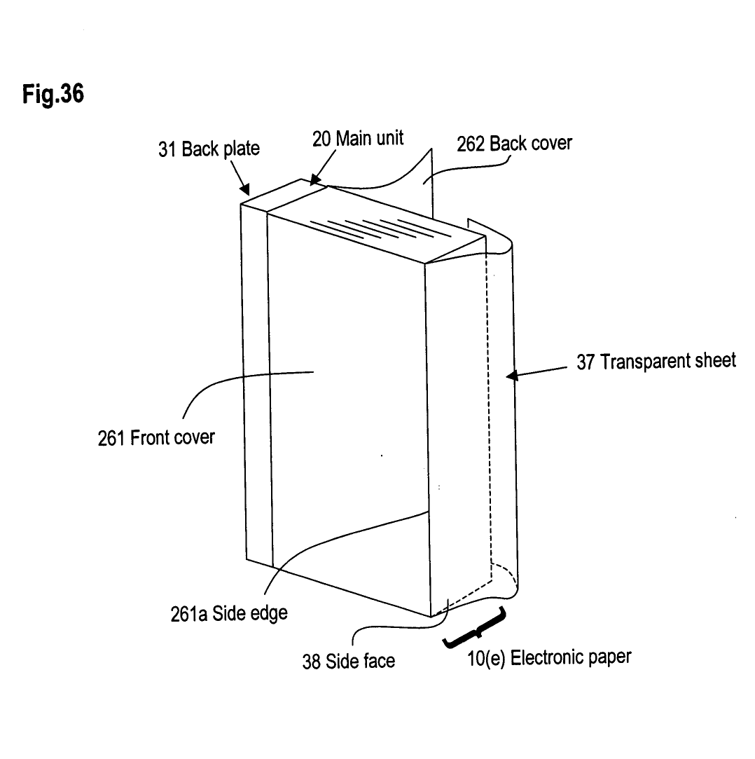

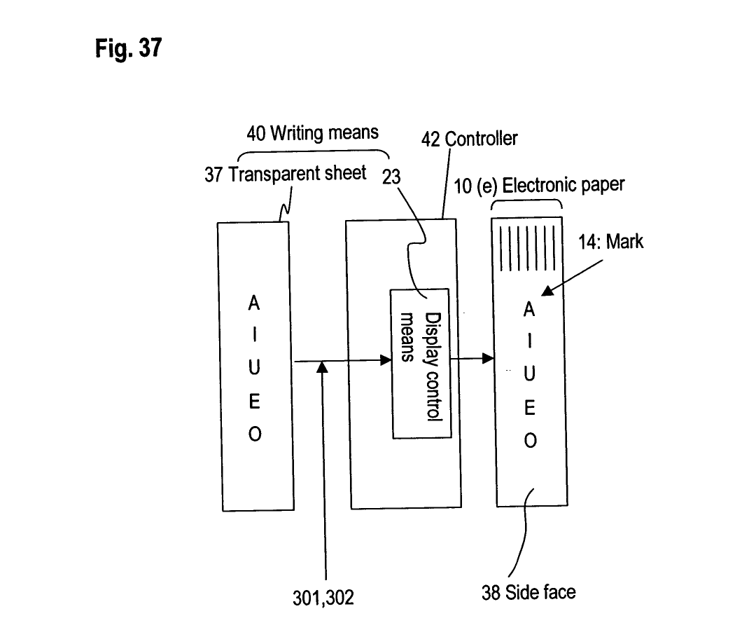

FIG. 36 is an outline view of the electronic paper file, and FIG. 37 is a block diagram of the electronic paper file. In this embodiment, the electronic paper file is provided with a writing means 40 for writing the mark 14 like the characters and figures onto the side face 38 formed by overlaying the specific number of electronic papers one after another, and canceling the mark 14 currently displayed.

The writing means 40 comprises the transparent sheet 37 provided with the digitizer function, and the display control means 23 provided to the controller 42 of the main unit 20. In FIG. 36, the transparent sheet 37 is fixed to the side edge 261a opposite to the side edge joining to the main unit 20, but the fixed position is not limited in particular if the transparent sheet 37 can be laid on the side face 38.

Next, the operation of the electronic paper file provided with the writing means 40 is exemplifies here. Besides, it presupposes that the front cover 261 is provided at a specific position with a switch key (not shown in the drawing) for selecting whether the mark is written or canceled by the writing means 40.

First, the specific number of electronic papers 10(e) attached to the main unit 20 are overlaid one after another so as to be inserted between the front cover 261 and the back cover 262 of the main unit 20. Thereby, the side face 38 is formed by the overlaid electronic papers 10(e).

Moreover, the transparent sheet 37 fixed to the side edge 261a is put on the side face 38. Thereby, the address of data is correlated with the address of the side face 38 (X, Y), those address are detected by the digitizer function provided to the transparent sheet 37. “X” corresponds to the number of pixels in the line direction (the number of pixels in the width direction that the electronic papers 10(e) are overlaid), and “Y” corresponds to the number of pixels in the column direction.

After selecting the writing means 40, the user draws a desired mark over the transparent sheet 37 with the writing device. By using the digitizer function, the transparent sheet 37 detects the address of contact where the transparent sheet 37 contacts with the writing device, and gives the display control means 23 the detected address (X, Y) as the position information.

According to the mark data and the position information 301 stored in the storage means of the display control means 23, the display control means 23 controls per pixel unit the indication range where the mark piece 14a is indicated, as follows.

For example, it is presupposed that by the processing described in the seventh embodiment, the mark data includes the information of “lighting”, the address (1,1), (1,2), (2,3), and (2,4) are sent out as the position information. In this case, the first and second pixels from the top of the vertical direction of the first electronic paper from the front cover 261, lights as the mark pieces 14a, and the third and fourth pixels from the top of the vertical direction of the second electronic paper from the front cover 261, lights as the mark pieces 14a.

And after selecting the cancel key, the user contacts the writing device with the mark being displayed on the side face 38, over the transparent sheet 37. The transparent sheet 37 gives the display control means 23 the position information 302 in the same way as above. Thereby, the display control means 23 cancels per pixel unit the mark pieces 14a corresponding to the position information 302.

As described above, it is possible in this embodiment to, as well as write the mark 14 onto the side face 38, cancel the mark 14 written onto the side face 38.

Besides, the above description exemplifies a configuration adopting the transparent sheet 37 in order to carry out the writing means 40. But it is also possible in case of adopting the pointing device such as the mouse, to obtain the same effect.

Though the above does not make particular reference, it is sure that the rotatable configuration explained in the second embodiment may be applied to the electronic paper file in this embodiment.

### EMBODIMENT 9

As described above, it is hard for a user to find an electronic paper displaying his desired main data in case of a conventional electronic paper file wherein a plurality of electronic papers is attached to the main unit. When the user wants to search the main data not including Contents or Index for his desired one, he must check all the content of the main data. It is very difficult and takes much time to find out his desired main data.

Then, the mark setting system adopted in this embodiment is designed that the mark can be set to the main data corresponding to a break point like a “Chapter” and a “section”, or corresponding to a word and a phrase frequently browsed. Accordingly, even in case of an electronic paper without a function displaying the Contents and the Index, the system makes it easy to predict an electronic paper displaying the desired main data.

It is true that the mark data is required to be set to the main data in order to display the main data based on the mark. The steps of making a personal computer execute the setting operation are explained hereinafter.

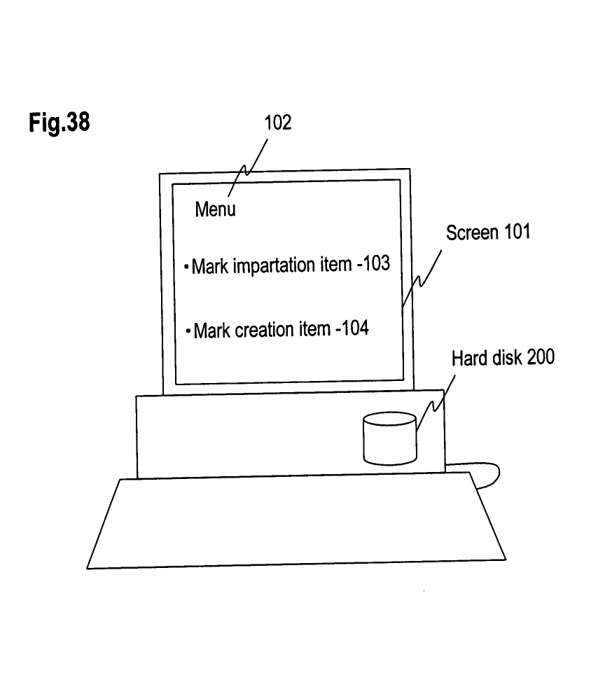

Main data to be displayed on the electronic paper is stored in a hard disk 200 shown in FIG. 38, per page unit. Under such condition, when the mark setting system is activated on a personal computer, a menu 102 of the system is displayed on a screen 101.

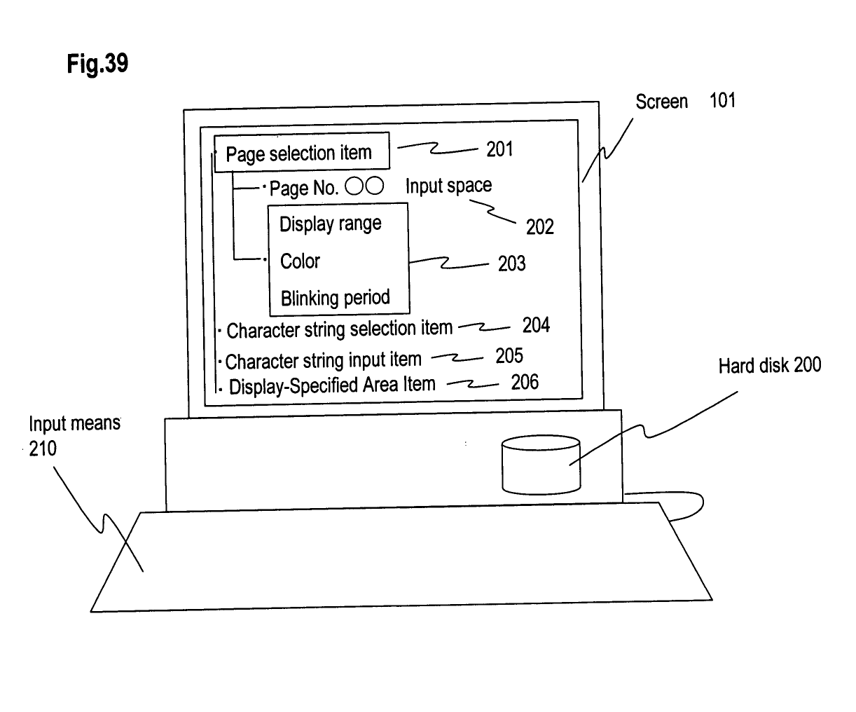

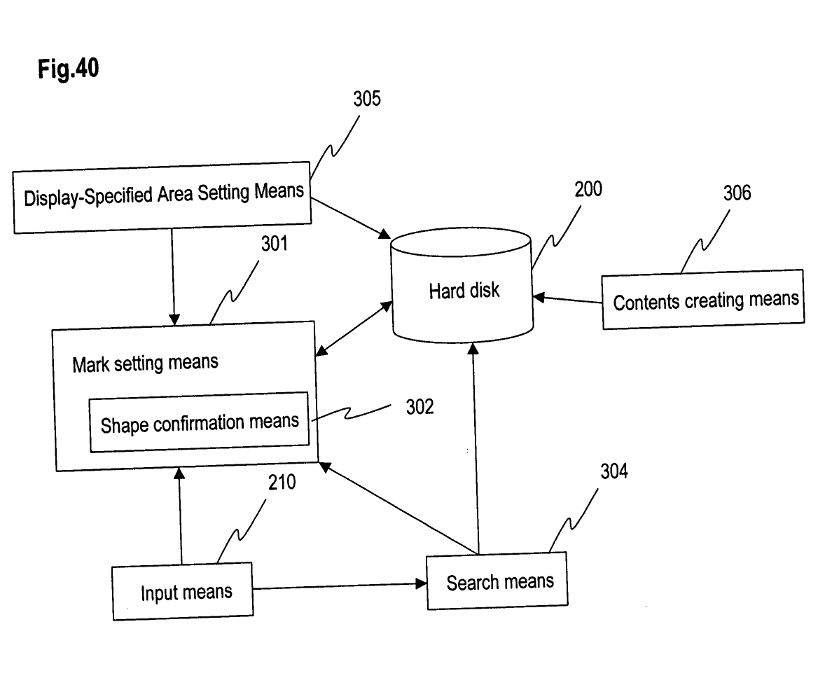

By selecting a mark impartation setup item 103 of the items included in the menu 102, a page selection item 201 is displayed as shown in FIG. 39. The user selects the page selection item 201 with the pointer through the input means 210 like the keyboard or the mouse. And by using the input means 210, the user inputs to an input space 202 the page number of the main data to be a target data of a mark. According to this input, the mark setting means 301 shown in FIG. 40 recognizes the main data corresponding to the inputted page number as a mark-target data.

In result, a shape setup item 203 (the “indication range”, the “color”, and the “blinking period”, for example) is displayed on the screen 101. After the user selects his desired conditions for each item, the color information, indication range information, and blinking period information for the mark (which are lumped together and called “mark-shape information”) are created according to such selection.

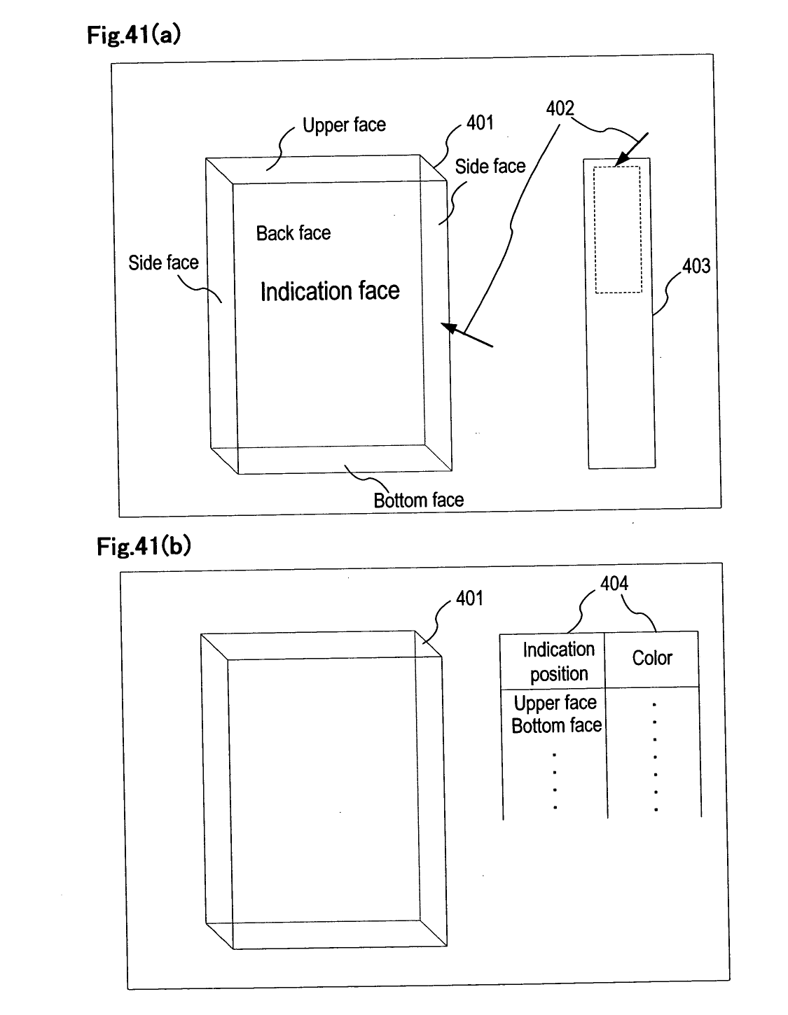

For instance, when the “indication range” of the shape setup item 203 is selected, the screen 101 displays a model 401 of the electronic paper 10 as described in the first embodiment, as shown in FIG. 41(a). The user can select a face of the electronic paper 10, said face that the user wants to indicate the mark, by using a pointer 402. In this case, the user selects a specific face (an indication face, for example), and then the selected face is displayed by the enlargement displaying 403 as shown in the right figure of FIG. 41(a). And the user selects a position to indicate the mark (right side edge 110, for example) and a shape of the mark by using the pointer 402.

The method of selecting a face to indicate the mark and a mark shape is not limited to the above one explained according to FIG. 41(a). That is to say, a pull-down menu 404 may be provided as shown in FIG. 41(b), and the face to display the mark and the mark shape may be selected from a list of the pull-down menu 404.

The method of selecting a “color” and a “blinking period” is not limited to the above, too. That is to say, the pull-down menus may be provided corresponding to the “color” and the “blinking period”, and the displayed color and the blinking period (or blinking or no blinking) may be selected from a list of the pull-down menu. In case of selecting the color, the user may create his unique color by adjusting the display level of each RGB colors, and select such created color. In case of selecting the blinking period, the user may select a specific time of the blinking period by using the input means 20.

When the user inputs all page numbers (or the first and the last page Nos.) included in a specific “Chapter” into the input space 202, the mark setting mans 301 recognizes the inputted all pages as the mark-target data. In case where a plurality of pages included in a specific “Chapter” is recognized as the mark-target data, the mark-shape information is created for only one page included in the specific “Chapter” by means of the shape setup item 203. Thereby, the same mark-shape information is automatically created for all the pages included in the specific “Chapter”.

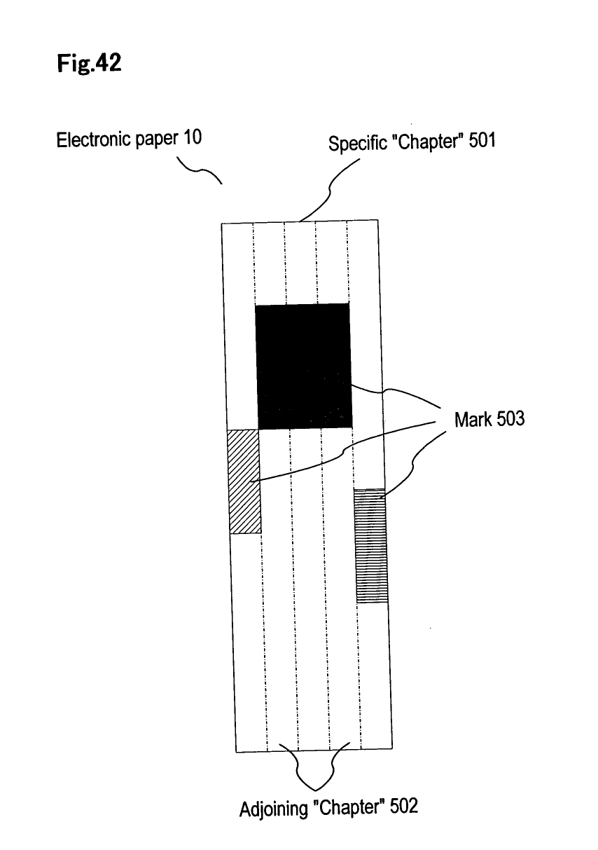

However, when the mark-shape information is created for a specific Chapter 501 in such way and the same mark-shape information is set to Chapters 502 adjoining to the Chapter 501, the mark 503 indicated on the electronic paper 10 can not show each chapter distinguishably as shown in FIG. 42. In order to solve such problem, it is designed that the mark-shape information created by the mark setting means 301 is transferred to a shape confirmation means 302 in FIG. 40. The shape confirmation means 302 judges whether the same mark-shape information is set to adjoining chapters or not, decides that the same mark-shape information is set to the adjoining chapter, and displays the result on the screen 101.

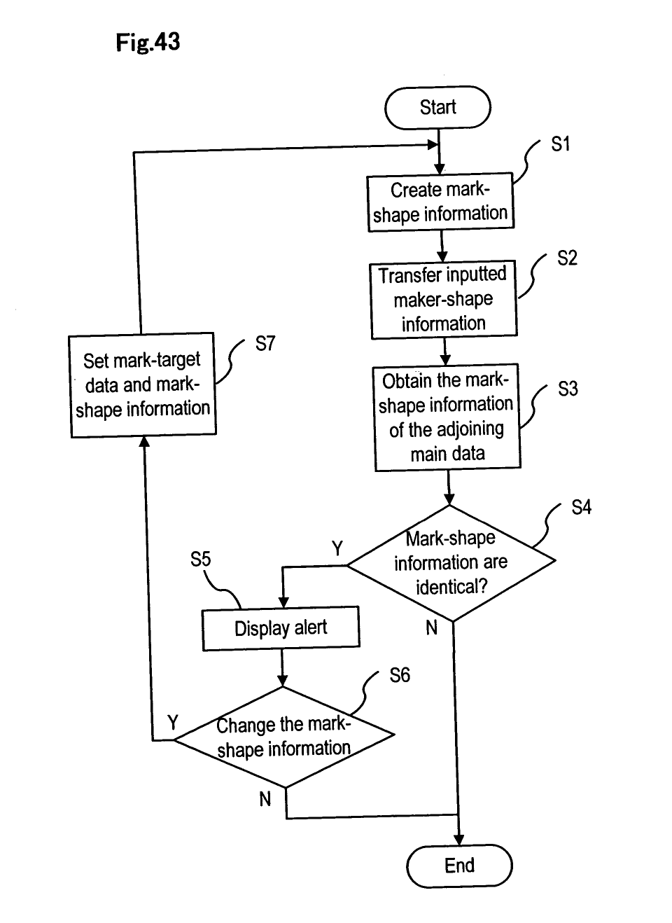

To be more precise, when the user creates his desired mark-shape information by the mark setting means 301 (FIG. 43, S1), thus created mark-shape information is transferred to the shape confirmation means 302 (FIG. 43, S2). The shape confirmation means 302 obtains from the hard disk 200 the mark-shape information of the main data of the chapter adjoining to the mark-target data (which is called “adjoining main data”) (FIG. 43, S3). Comparing the created mark-shape information and the mark-shape information set to the adjoining main data, the shape confirmation means judges whether those mark-shape information are identical or not (FIG. 43, S4).

In the comparing step, when it is decided that the both mark-shape information are not identical, the created mark-shape information is set to a specific position of the main data corresponding to the page of the mark-target data.

On the other hand, in the comparing step, when the both mark-shape information are identical, the screen 101 displays an alert because the same mark is indicated on the electronic paper 10 displaying the adjoining chapter as shown in FIG. 42 (FIG. 43, S5).

When the alert is displayed, the user selects a change of the mark-shape information corresponding to the indistinguishable mark (FIG. 43, S6). For instance, if it is not necessary to make the mark border clear, the user selects a button of “no change”. On the other hand, if the user wants to make the mark border clear, he selects a button of “change”, and changes the created mark-shape information or the mark-shape information set to the adjoining main data. The mark-shape information, which is created due to the change, is transferred again to the shape confirmation means 302 (FIG. 43, S7). The subsequent step is the same as the comparing step.

The mark-shape information may be set to a specific position of the main data for the page to be the mark-target data (at a top of the main data, for example).

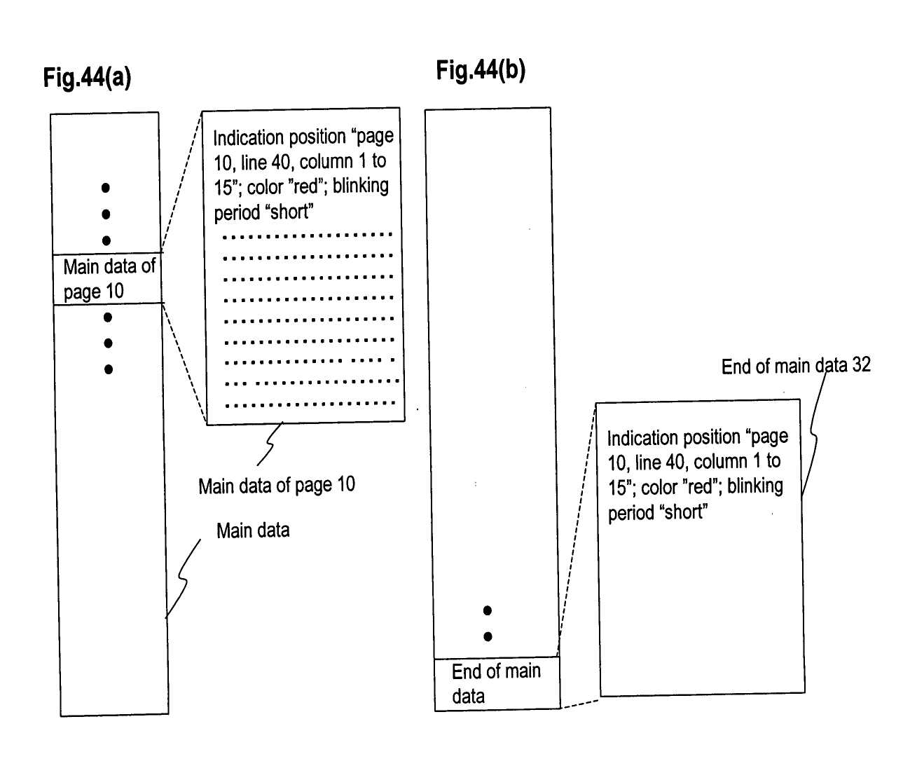

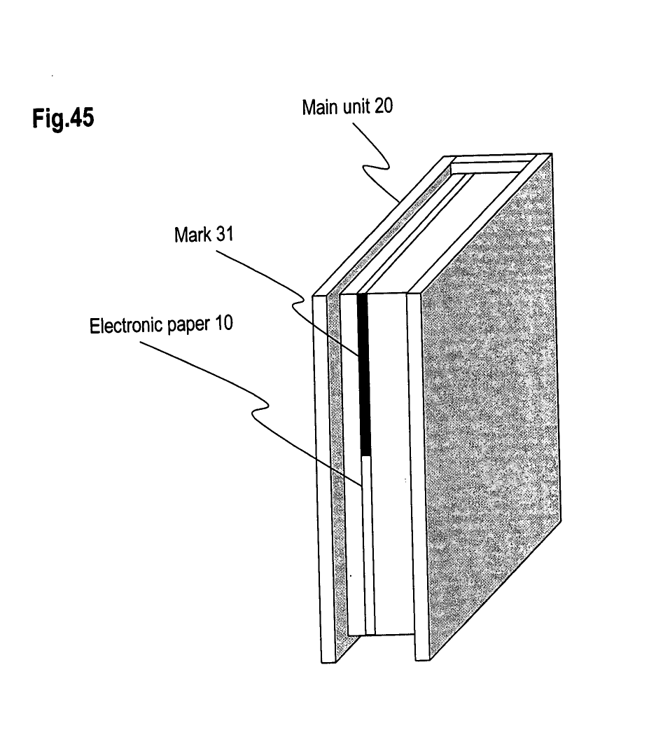

For example, where the number of words per line to be displayed on the electronic paper 10 is 40 and the number of lines per page is 30, the user selects from the mark setting means 301 the conditions like “Page 10”, “side face”, “lines 1-15”, “red”, and “short period of blinking” as the mark-shape information. Thereby, the mark-shape information is set to the top of the main data for page 10. As FIG. 44(a) shows an example, this sets the mark-shape information like the indication position of the mark is “page 10, col. 40, lines 1-15”, the color of the mark is “red”, the blinking period is “short”. When an electronic paper displays the main data to which the mark-shape information is set, the red mark 31 is indicated in a short blinking period on lines 1-15 of the side face of the electronic paper 30 that displays page 10 of the main data, as shown in FIG. 45.

Besides, as shown in FIG. 44(b), the mark-shape information may be set to the end portion 32 of the main data. Additionally, if the electronic paper 10 is provided with the storage means 28, the storage means 28 may store the main data including the mark-shape information to be displayed on the electronic paper 10. Thereby, it is possible to indicate the mark on the electronic paper 10, even when the electronic paper 10 is removed from the main unit 20 and then attached to the other main unit 20.

As described above, if the electronic paper file is configured so as to display both the main data and the mark on the electronic paper 10, it is easy for the user to find out the electronic paper displaying his desired page by finding a specific mark instead of checking the main data displayed on the electronic paper.

### EMBODIMENT 10

This embodiment explains about only different points from the ninth embodiment.

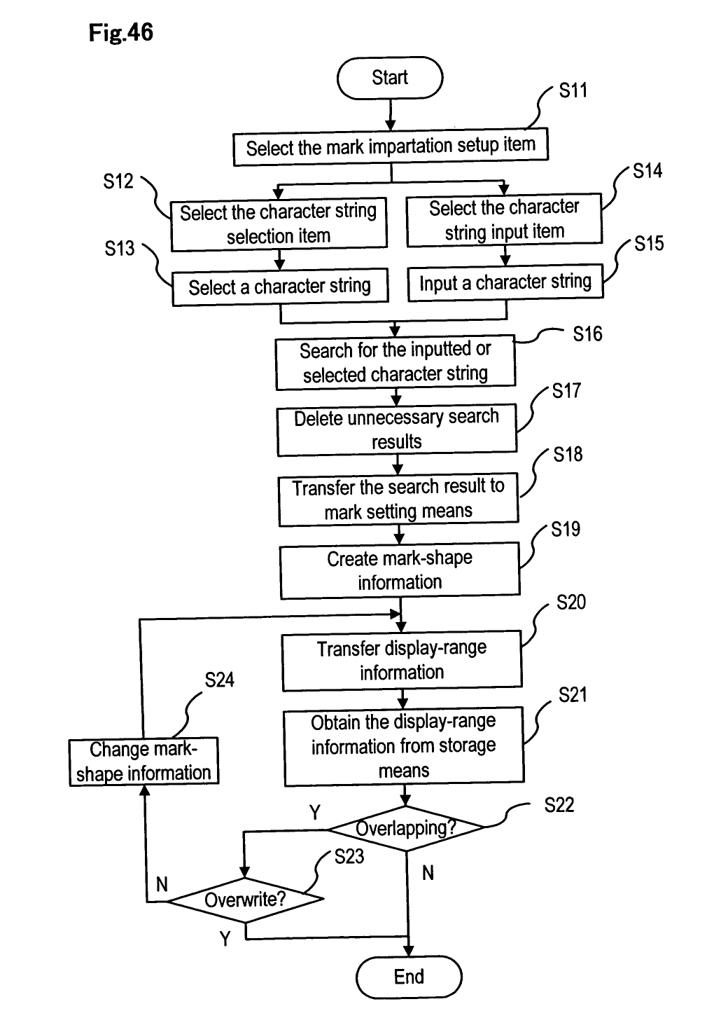

While the screen 101 is displaying the menu 102 shown in FIG. 38, the user selects the mark impartation setup item 103 from the items in the menu 102, hereupon the mark setting means 301 is activated. And, as shown in FIG. 39, a character string selection item 204 and a character string input item 205 are displayed along with the shape setup item 203 on the screen 101 (FIG. 46, S11).

When the user selects the character string selection item 204 (FIG. 46, S12), the screen 101 displays the main data. The user selects from the 5 displayed content a character string as a search target data, by means of the pointer (FIG. 46, S13). In addition, when the user selects the character string input item 205 (FIG. 46, S14), the screen displays a space for inputting a character string. The user inputs a desired character string by means of the input means 210 (FIG. 46, S15).

The character string inputted in such way is transferred to a search means 304 shown in FIG. 40. The search means 304 searches automatically the main data for the inputted character string as the search target data (FIG. 46, S16). And when the page numbers including the inputted character string and the positions of the character string in the detected pages (addresses) are found out, the screen 101 displays this search result.

And here, the user deletes from the displayed search result the page numbers and the character string positions (addresses) that he does not want to set the mark-shape information therein (FIG. 46, S17). The search result except those deleted by the user is transferred to the mark setting means 301 (FIG. 46, S18).

The transferred search result becomes the mark target data automatically.

After the search result is transferred, the user creates the mark-shape information by means of the shape setup item 203 displayed on the screen 101. For instance, by selecting the shape setup item 203 (the indication range, the color, and the blinking period, for example), the user can input his desired conditions to the respective items. After the user inputs his desired conditions to these items, the mark-shape information is created based on the inputted conditions.

The invention may be provided with a pull-down menu with which the user can select a style of the character string, a background color of the character string, blinking or no blinking of the character string, and indication of the mark on the same line or on the line end of the character string range. The user may create the mark-shape information by the pull-down menu.

The mark-shape information of the specific character string created as above has sometimes the same indication range as that of the other character string. In order to avoid such trouble, the invention may adopt the following method.

That is to say, when the mark-shape information is created for the specific character string (FIG. 46, S1), the indication range information of the created mark-shape information is transferred to the shape confirmation means 302 (FIG. 46, S20). Then the shape confirmation means 302 obtains the indication range information of the mark-shape information from the main data stored in the hard disk 200 (FIG. 46, S21), and judges whether the obtained indication range information overlaps the indication range of the created mark-shape information or not (FIG. 46, S22).

If the shape confirmation means 302 decided that the respective indication range information do not overlap each other, the created mark-shape information is set to the specific position on the main data including the mark-shape information (the top of the main data corresponding to the page, for example). On the other hand, if the shape confirmation means 302 decided that both the indication range information overlap, the screen 101 displays a button for selecting to “overwrite” or “not overwrite” the created mark-shape information (FIG. 46, S23).

If the button of “not overwrite” is selected (FIG. 46, S23, N), the screen 101 displays the input space 202, the character string selection item 204 or the character string input item 205, again. When the mark target data is selected after the specific conditions are inputted to these items in the way described in the first embodiment, the shape setup item 203 changes the mark-shape information so as not to overlap the other indication range of the mark (FIG. 46, S24). After the change, the changed mark-shape information is re-transferred to the shape confirmation means 302, and is compared with the other mark regarding the indication range. By the comparing procedure, it is possible to avoid such case that a plurality of mark-shape information is set to the same position; therefore all the mark can be indicated without overlapping each other.

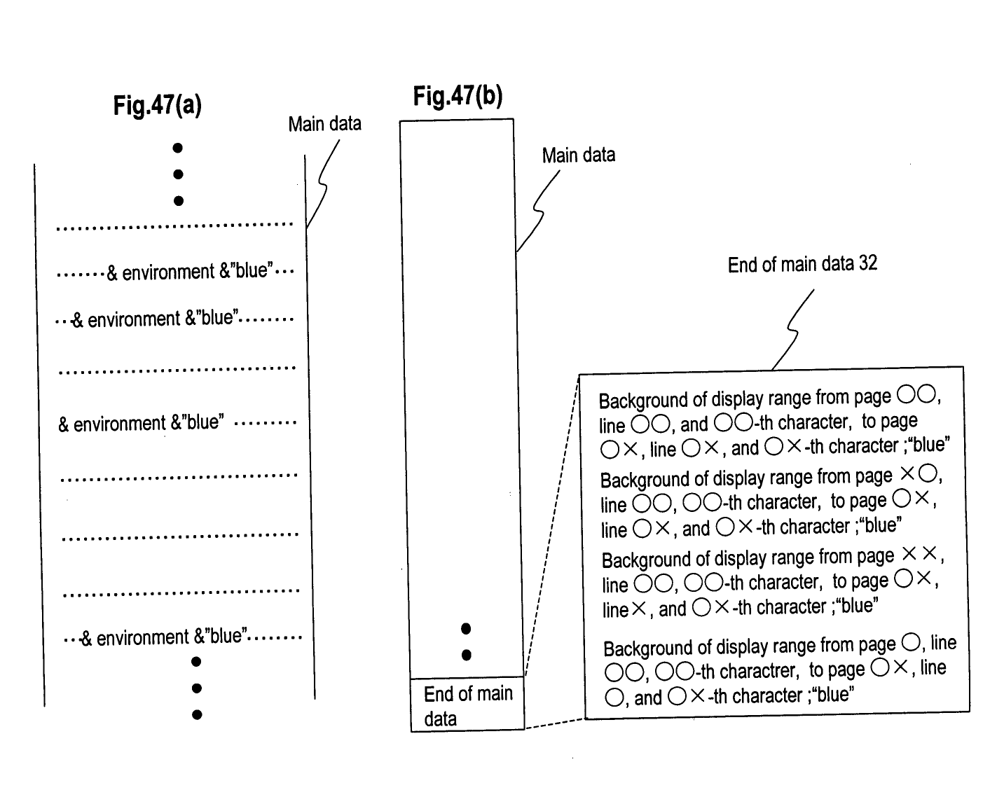

When the user selects a character string “environment” as the mark target data as shown in FIG. 47(a), the information expressing the mark target data (which is described here “&”) is set to the top and end of a code expressing the “environment” (which will be described “environment” simply). After the user creates the mark information that the mark is indicated in blue, “indicate the character string in blue” is set to a position just behind “&”. Thereby, the “environment” intervened between “&” s is indicated on the electronic paper in blue.

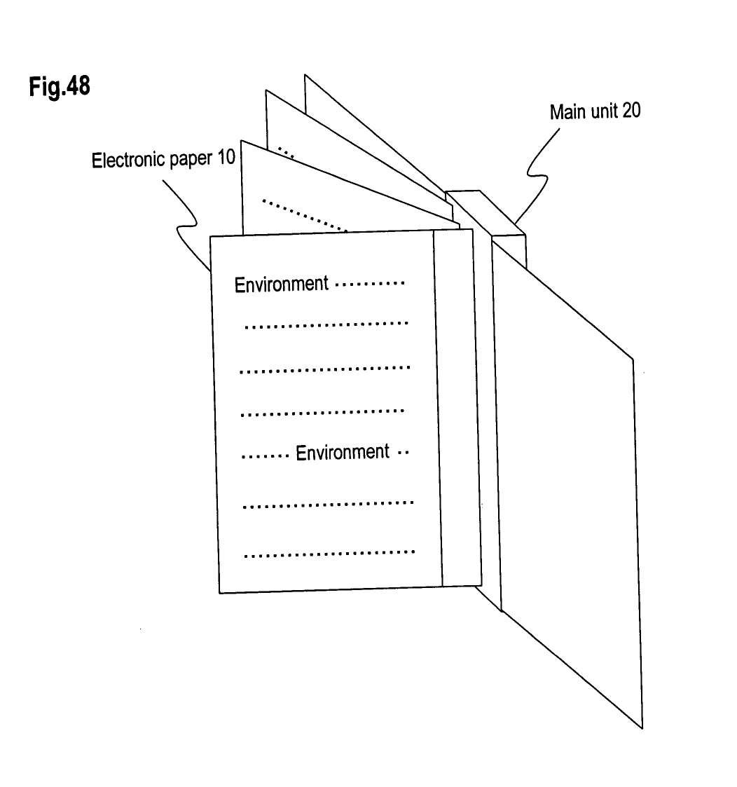

The mark-shape information may be set to the end of the main data as shown in FIG. 47(b). After the search means 304 searches for the address of “environment” to be the mark target data, the mark setting means 301 retains the address of “environment” within the main data as the mark target data. Therefore the information that the character string with this address is indicated in blue may be set to the end 32 of the main data. In case of displaying the main data with the mark-shape information, the “environment” is indicated in blue as shown in FIG. 48.

### EMBODIMENT 11

This embodiment explains about only different points from the ninth or tenth embodiment.

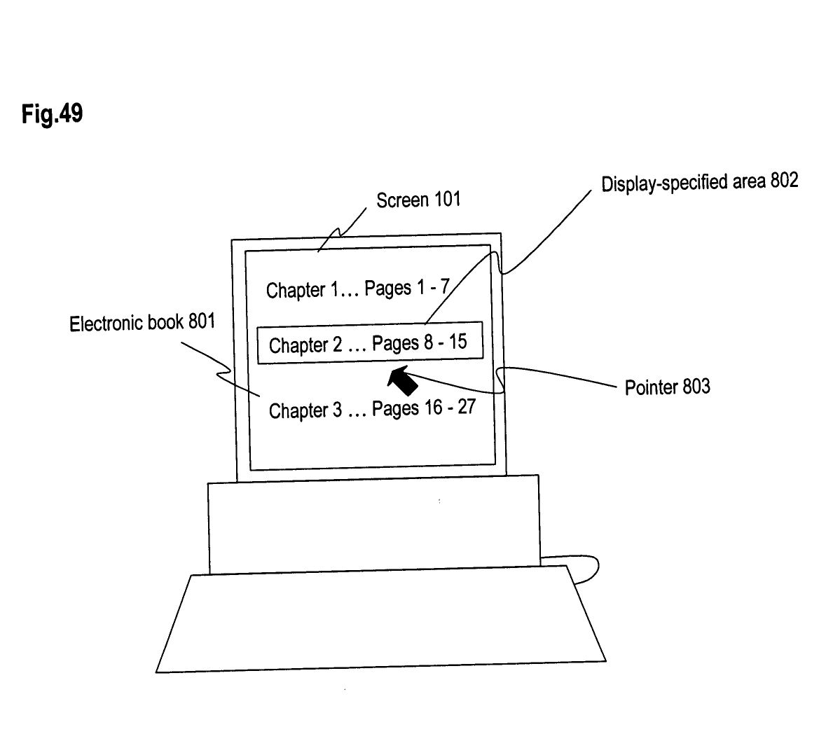

While the screen 101 is displaying the menu 102 shown in FIG. 38, the user selects the mark impartation setup item 103 from the items in the menu 102. After the mark impartation setup item 103 is selected, the screen displays a display-specified area item 206 as shown in FIG. 39. By selecting the display-specified area item 206, a display-specified area setting means 305 is activated. And the screen 101 displays the main data stored in the hard disk 200 (electronic book 801, for example) as shown in FIG. 49.

Next, the user surrounds and selects a specific display area (such as “Chapter 2 . . . pages 8-15” of the Contents, for example) of the display content of the electronic book 801 displayed on the screen 101 by means of the pointer. Thereby, the display-specified area setting means 305 can define the selected area as a display-specified area 802.

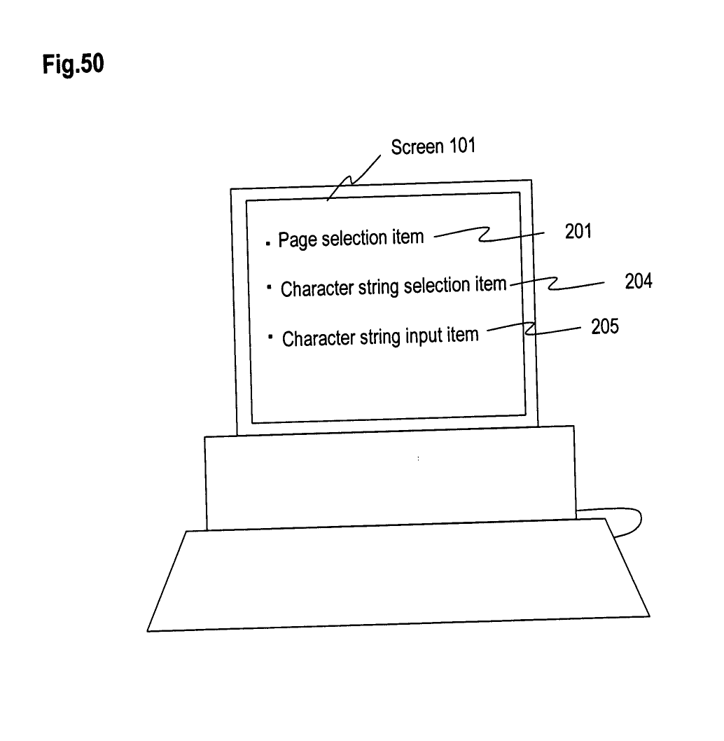

Regarding the display-specified area 802 defined as above, the display-specified area setting means 305 transfers the position information to the mark setting means 301, and displays on the screen 101 the page selection item 201, the character string selection item 204, and the character string input item 205, as shown in FIG. 50. According to this displaying, the user selects the mark target data by the mark setting means 301 and creates the mark-shape information like the ninth or tenth embodiment. Here, the user selects pages corresponding to the display-specified area 802 (pages 8 to 15) as the mark target data, and creates the mark-shape information to the effect that the display position of the mark is “whole side face” and the color is “yellow”, in the same way of the ninth or tenth embodiment.

The selected mark target data and mark-shape information are to be stored in the hard disk 200 being correlated with the information displayed in the display-specified area 802 (which is called “display-specified data”).

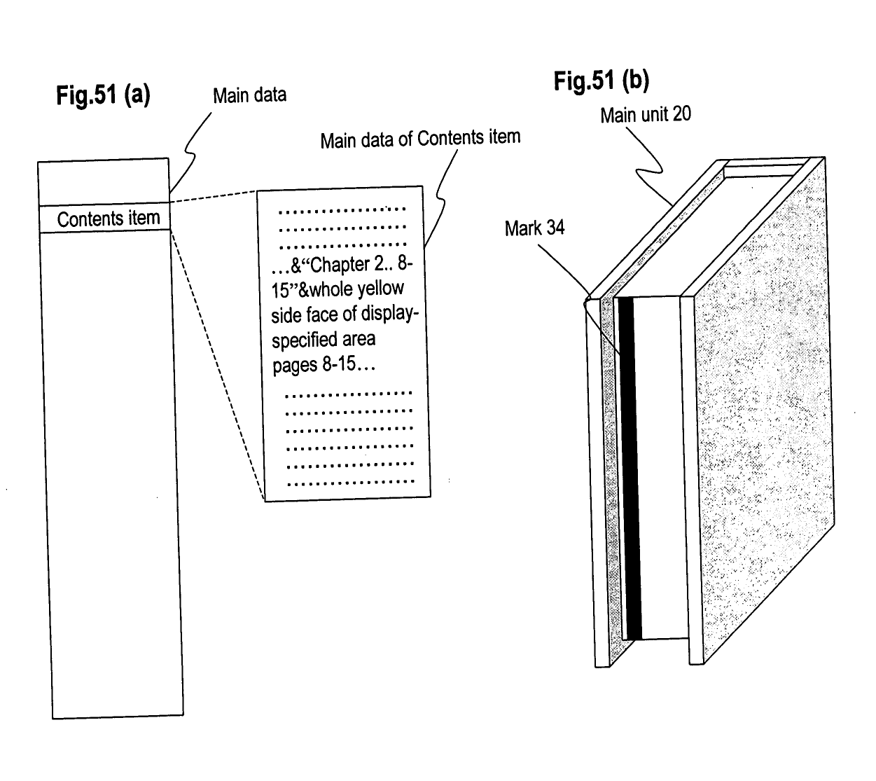

When the user wants to browse the “Chapter 2” of the main data on the electronic paper 10, he first displays this main data on the electronic paper 10. Next, he selects an area of the Contents displayed as “Chapter 2 . . . Pages 8-15” (that is, the display-specified area 802) by means of the pointer as shown FIG. 51(a). According to the mark target data and the mark-shape information correlated with the selected display-specified area 802, the electronic paper 10 displaying pages 8 to 15 indicates the yellow mark 34 on the whole side face, as shown in FIG. 51(b). The lighting yellow mark is imparted to the page displaying the content of the Chapter 2, so that the user can find this page displaying the Chapter 2 speedy.

The user may select a title of the Contents as the display-specified area 802, and select the page displaying the content of the title as the mark target data with which the display-specified area 802 should be correlated. Thereby, the electronic paper 10 displaying the content of the title makes the mark light, so that it makes it possible to find out the page displaying the content of the tile speedy.

Likewise, the user may select a specific character string of the Index item of the main data as the display-specified area 802, and selects the page displaying the character string as the mark target data with which the display-specified area 802 should be correlated, and sets the mark indication range to the side face of this page. Thereby, when the user browses the main data on the electronic paper 10, the mark is indicated on the page indicating the character string by selecting the specific character string of the Index item with the pointer. In result, the user can search the main data quickly.

In addition, the display-specified data may be displayed in the same shape (the same color, for example) as the mark corresponding to the display-specified data, while the mark is displayed. In this case, after specifying the stored mark-shape information correlated with the display-specified data, the color information included in the mark-shape information may be set to the display-specified data.

As described above, it is designed in this embodiment that the mark correlated with the display-specified area 802 is indicated when the user selects the display-specified area 802 correlated with the mark. Accordingly, even if a plurality of the mark-shape information has an overlapping indication range, the shape confirmation means 302 does not need to judge whether the indication range of the mark-shape information overlaps the other.

Moreover, since it is designed in the invention of this embodiment to indicate only a desired mark, even when a plurality of marks is set at once, the user can find out a desired mark among them with ease. And it is possible to display a plurality of marks on the same position, therefore, when the indication range of the mark-shape information is set, the indication range of this mark is not limited by the other mark.

### EMBODIMENT 12

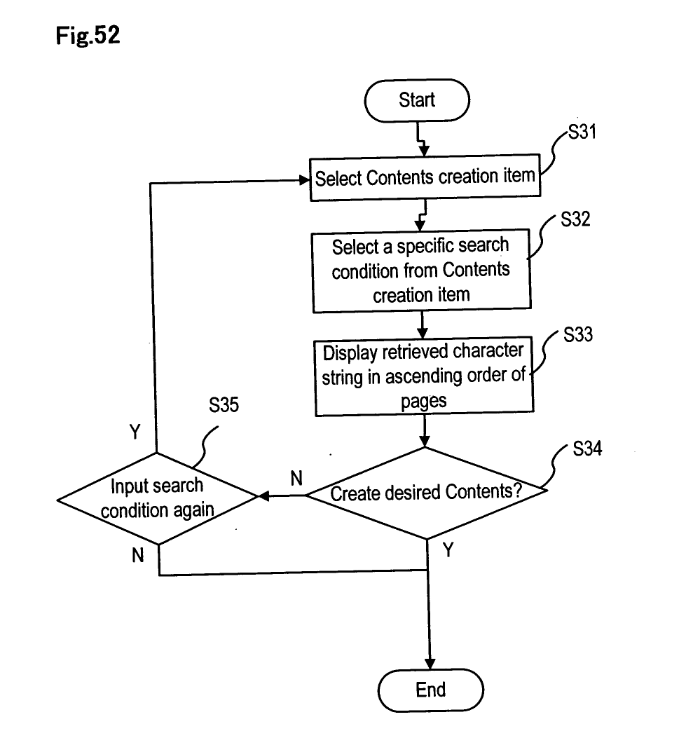

According to FIG. 52, here is explained about a Contents creating means 306 for creating the Contents from the main data without the Contents, regarding different points from the eleventh embodiment.

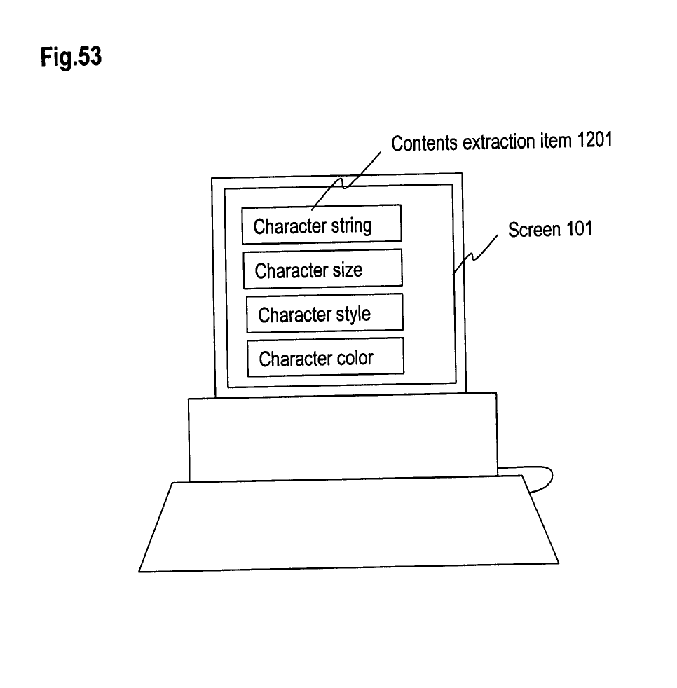

First, while the screen 101 displays the menu 102, the user selects a Contents creation item 104 displayed on the screen 101. Then the Contents creating means 306 is activated (FIG. 52, S31). After the activation of the Contents creating means 306, the screen 101 displays a contents extraction item 1201 for inputting a specific character string, a character size, a character style, and a character color as shown in FIG. 53.

Then the user inputs a character sting to be the contents (a character string such “Chapter”, or “section”, for example) to the contents extraction item 1201. If the inputted character string such as the “Chapter” or the “Section” is different in the character size, the character style, and the character color from the character string of the text, the user may input the character size, the character style and the character color of the character string, “chapter” or “section”, to the Contents extraction item 1201.

According to such step, the Contents creating means 306 searches the specific main data based on the search condition of the character string, “Chapter” or “Section”, inputted to the Contents extraction item 1201 (FIG. 52, S32). As well as the retrieved character strings are extracted in the ascending order of pages, the addresses of the character strings in the main data (Page No., for example) are displayed on the screen 101 together with the character strings (FIG. 52, S33). If the Contents created in such way does not match to the user's requirement (FIG. 52, S34, N), the user can select whether he inputs or does not input a specific search condition to the Contents extraction item 1201 again (FIG. 52, S35).

As described above, the invention of this embodiment is designed so that the Contents can be created. Accordingly, even when the electronic paper 10 displays the main data without the Contents, the user can easily find out the electronic paper 10 displaying his desired main data, Besides, if the computer and the electronic paper are connected electrically each other and the electronic paper 10 can display the main data that the computer displays on the screen 101, the electronic paper can be used as the display medium.

Additionally, when the user sets the mark-shape information using the electronic paper as the display medium, it may be designed that, while indicating the mark on the electronic paper 10 in real according to the mark-shape information, the user may set the mark-shape information confirming the displayed mark.

Moreover, as described above, the invention presupposes that the mark setting system is made to work on the personal computer, however, the invention is not limited to this. That is to say, even in case of the electronic paper 10 or PDA, if the device is provided with the environment capable of operating the mark setting system, the mark setting procedure can be executed.

1. An electronic paper file comprising an electronic paper that is a flexible display medium, and a main unit attachable with a plurality of the electronic papers, said electronic paper file comprising:
a mark indication control means controlling the indication of a mark on the electronic paper.

2. The electronic paper file according to claim 1, wherein the mark indication control means controls the indication of a mark on a side edge of a display unit of the electronic paper.

3. The electronic paper file according to claim 1, wherein the mark indication control means controls the indication of a mark based on mark data indicating at least one of the indication position, a color, and the indication type of said mark.

4. The electronic paper file according to claim 3, wherein the mark indication control means retains the mark data and displays a mark based on the retained mark data even after the power is turned off.

5. The electronic paper file according to claim 3, wherein the mark indication control means retains the mark data and displays a mark based on the retained mark data when the power is turned off and then turned on again.

6. The electronic paper file according to claim 1, wherein the main unit or the electronic paper is provided with a storage means for storing main data to be displayed on the electronic paper.

7. The electronic paper file according to claim 1, which further comprising:
a mark setting means for instructing the mark indication control means to display both main data to be displayed on the electronic paper and the mark corresponding to the main data.

8. The electronic paper file according to claim 7, wherein the mark setting means selects the main data displayed on the display unit of the electronic paper, and instructs the mark indication control means to display both the selected main data and the mark corresponding to the main data.

9. The electronic paper file according to claim 7, wherein the mark setting means detects an open electronic paper, and instructs the mark indication control means to display both the main data displayed on the detected electronic paper and the mark corresponding to the main data.

10. The electronic paper file according to claim 1, which further comprising:
a Content-Index display control means for controlling the displaying of Contents or Index on the electronic paper.

11. The electronic paper file according to claim 10, which further comprising:
a selecting means for selecting a search target data;
a search control means for searching the main data based on the data selected by the selecting means; and
the mark indication control means for controlling the indication of the mark based on the search result of the search control means.

12. The electronic paper file according to claim 11, wherein the selecting means selects search target data based on at least one of the Contents, the Index, and the main data that are displayed on the electronic paper.

13. The electronic paper file according to claim 10, wherein the mark indication control means manages the specific number of electronic papers as a group, and controls the indication of a same mark on all the electronic papers included in the same group.

14. The electronic paper file according to claim 1, wherein the mark indication control means for controlling the indication of a mark on a side face formed by laying the specific number of the electronic papers one after another.

15. The electronic paper file according to claim 14, which further comprising:
a writing means for writing a mark on the side face formed by laying the specific number of the electronic papers one after another.

16. The electronic paper file according to either one of claims 1 to 15, wherein the electronic paper comprises a display layer for displaying the main data and a light emitting layer for illuminating the display layer.

17. The electronic paper file according to claim 16, wherein a nonvolatile display medium is used as a display medium of the display layer.

18. The electronic paper file according to claim 16, wherein an organic or an inorganic electro luminescence is used as a display medium of the light emitting layer.

19. The electronic paper file according to either one of claims 1 to 15, wherein the electronic paper is attached to or removed from the main unit freely by providing one of a pair of connecting terminals to one end of the display unit of the electronic paper and the other connecting terminal to the main unit, said connecting terminal with the physical and electric connecting function.

20. The electronic paper file according to claim 19, wherein the other connecting terminal is fixed to an arrangement position on the main unit.

21. The electronic paper file according to claim 19, wherein a connecting unit, which is configured by jointing a plurality of rotatable axis parts and the other connecting terminals in the axis direction so as to be rotatable mutually, is fixed rotatably to the main unit.

22. The electronic paper file according to claim 19, which comprising:
an attachment detecting means for detecting whether the one connecting terminal is attached to the other connecting terminal or not; and
the mark indication control means for controlling the indication of the mark based on the detected result of the attachment detecting means.

23. A mark setting system for setting a specific shape of mark to main data displayed on an electronic paper which is a flexible display medium, said system comprising:
a mark setting means for selecting data to be a mark target data from the main data, and setting the mark-shape information to the selected data.

24. The mark setting system according to claim 23, wherein the mark setting means sets the mark-shape information per page unit of the main data.

25. The mark setting system according to claim 23, wherein the mark setting means sets the mark-shape information per specified character string.

26. The mark setting system according to claim 23, wherein the mark setting means is provided with a shape confirmation means for judging at the time of setting a display range of a mark whether the display ranges of the mark and the other mark overlap each other.

27. The mark setting system according to claim 23, wherein the shape confirmation means judges whether the mark-shape information set to a specific electronic paper is the same as the mark-shape information set to the other electronic papers adjoining to the electronic paper.

28. The mark setting system according to claim 23, wherein the mark setting means is provided with a search means for searching the main data for a specified character string.

29. The mark setting system according to claim 23, which further comprising:
a display-specified area setting means for selecting from the main data a display-specified area displaying a mark.

30. The mark setting system according to claim 23, which further comprising:
a Contents creating means for obtaining from the main data the data matching to specific conditions and creating Contents based on the obtained data.

31. A program of a computer for setting a specific shape of mark to an electronic paper that is a flexible display medium, said program working the computer as a mark setting means for selecting a mark target data from main data and setting mark-shape information to the selected data.
